(19) United States
(12) Patent Application Publication
(10) Pub. No.: US 2002/0186818 A1
(43) Pub. Date: Dec. 12, 2002

(54) System and method for building and manipulating a centralized measurement value database

(75) Inventors: Claude Arnaud, Mill Valley, CA (US); Barry J. Linder, Danville, CA (US); Daniel Steines, Palo Alto, CA (US); Philipp Lang, Lexington, MA (US)

Correspondence Address: SUGHRUE MION, PLLC, 1010 EL CAMINO REAL, SUITE 300, MENLO PARK, CA, 94025, US

(73) Assignee: OsteoNet, Inc., Menlo Park, CA

(21) Appl. No.: 10/087,071

(22) Filed: Feb. 27, 2002

Related U.S. Application Data
(63) Continuation-in-part of application No. 09/942,528, filed on Aug. 29, 2001.
(60) Provisional application No. 60/228,591, filed on Aug. 29, 2000.

(51) Int. Cl. H05G 1/28

(52) U.S. Cl. 378/165

(57) ABSTRACT

A system and method for building and/or manipulating a centralized medical image quantitative information database aid in diagnosing diseases, identifying prevalence of diseases, and analyzing market penetration data and efficacy of different drugs. In one embodiment, the diseases are bone-related, such as osteoporosis and osteoarthritis. Subjects' medical images, personal and treatment information are obtained at information collection terminals, for example, at medical and/or dental facilities, and are transferred to a central database, either directly or through a system server. Quantitative information is derived from the medical images, and stored in a central database, associated with subjects' personal and treatment information. Authorized users, such as medical officials and/or pharmaceutical companies, can access the database, either directly or through the central server, to diagnose diseases and perform statistical analysis on the stored data. Decisions can be made regarding marketing of drugs for treating the diseases in question, based on analysis of efficacy, market penetration, and performance of competitive drugs.

### REFERENCE TO RELATED APPLICATIONS

This application is a continuation-in-part of U.S. patent application Ser. No. 09/942,528, filed Aug. 29, 2001, and entitled METHODS AND DEVICES FOR QUANTITATIVE ANALYSIS OF MEDICAL IMAGES, which claims the benefit under 35 U.S.C. §119(e) of U.S. Provisional Patent Application No. 60/228,591, filed Aug. 29, 2000. These applications are incorporated by reference into the present application.

### BACKGROUND OF THE INVENTION

1. Field of the Invention

The present invention relates generally to storage of medical measurement values, and more particularly, to a method and system for collecting, processing, and storing medical data derived from medical images, or other diagnostic information, and related patient and treatment information, to diagnose diseases, and to enable analysis of drug efficacy and market penetration for different drugs.

2. Description of the Related Art

X-rays and other medical imaging techniques are important diagnostic tools. However, the measurement values generated by conventional isolated medical imaging diagnostic equipment often are inaccessible to remote users, with images being available either as developed films, or stored in hard drives in the equipment. As a result, it can be inconvenient for remote users to utilize the data contained in those images for disease diagnosis and epidemiological analysis. It also may be impractical to use the measurement values, separately stored in that isolated equipment, to perform regional comparisons to determine the prevalence of diseases and to perform statistical analysis of the measurement values.

In addition, known medical imaging diagnostic systems do not collect and store subjects' treatment information, and therefore cannot track improvements in subjects' conditions as a result of various treatments, and compare the therapeutic efficacy of different drugs. These conventional systems also cannot provide pharmaceutical manufacturers with useful marketing strategy information, to help identify potential or growing markets for given drugs, and current market share information for different drugs. Moreover, quality assurance and analysis of image quality of known medical imaging diagnostic systems is performed on site. Known medical imaging diagnostic systems do not provide for remote quality assurance of image quality.

The foregoing limitations are not limited to medical image based information. It would be similarly desirable to centralize information for a variety of diseases and disorders for which patients may be undergoing treatment, for which correspondingly relevant information can be obtained in similar fashion.

### SUMMARY OF THE INVENTION

In view of the foregoing, according to one feature of the invention, diagnostic information from medical images is derived, and stored in a database, along with relevant patient and treatment information. In one embodiment, this information is obtained from x-rays, for example dental x-rays or x-rays of the hip and spine (or one or more vertebral bodies thereof), which may be taken periodically and which therefore are convenient to obtain, and relatively convenient to transmit remotely (along with the relevant patient and treatment information). X-rays of other skeletal areas include, by way of example, the forearm, upper arm, hand, wrist, lower leg, thigh, foot, ankle, knee joint, elbow joint, shoulder joint, ribs, and cranium. Of course, some of these areas may not be x-rayed as frequently. However, to the extent that it is possible to correlate bone data taken from different bones in the body, the use of x-rays of different skeletal areas can prove useful. In other embodiments, other imaging techniques yield the information. In yet other embodiments, non-image based diagnostic information is derived, and treated similarly.

According to another feature of the invention, this diagnostic information can be used to identify prevalence of disease, either geographically or demographically (or both). Disease prevalence information, derived in this fashion, can be used to identify market strategies for drug companies. In addition, information on drug efficacy can be derived, again, on either a geographic or a demographic basis (or both).

Other features and objects of the present invention will be apparent from the following detailed description.

### BRIEF DESCRIPTION OF THE DRAWINGS

FIG. 1 illustrates an embodiment of the overall architecture of a system for building and manipulating a measurement value database of the present invention.

FIG. 2 illustrates an example of network enabled quantitative x-ray analysis useful in monitoring disease prevalence.

FIGS. 3A to 3I are schematic representations of database table structures for the central database 100 of the present invention.

FIG. 4 shows the inter-relationship among tables and files of the central database 100.

FIG. 5A is a flow diagram illustrating an embodiment of the method of the present invention for manipulating the central database 100 to produce market penetration data of different drugs.

FIG. 5B is an example of the results obtained by the method illustrated in FIG. 5A.

FIG. 6A is a flow diagram illustrating an embodiment of the method of the present invention for manipulating the central database 100 to compare efficacy of different drugs.

FIG. 6B is an example of a result obtained by the method in FIG. 6A.

FIG. 7 is a flow diagram illustrating an embodiment of the method of the present invention for manipulating the central database 100 to produce screening rates for diseases.

FIG. 8 illustrates an exemplary dental x-ray film holder, including a calibration phantom.

FIG. 9 illustrates another exemplary dental x-ray film holder, including a calibration phantom.

### DETAILED DESCRIPTION OF EMBODIMENTS

Before describing the present invention in detail, it is to be understood that this invention is not limited to particular formulations or process parameters as such may, of course, vary. It is also to be understood that the terminology used herein is for the purpose of describing particular embodiments of the invention only, and is not intended to be limiting.

The practice of the present invention employs, unless otherwise indicated, conventional methods of database storage and manipulation, within the skill of the art. Such techniques are explained fully in the literature. See, e.g., Numerical Mathematical Analysis, Third Edition, by J. B. Scarborough, 1955, John Hopkins Press, publisher; System Analysis and Design Methods, by Jeffrey L. Whitten, et al., Fourth Edition, 1997, Richard D. Irwin, publisher; Modem Database Management, by Fred R. McFadden, et al., Fifth Edition, 1999, Addison-Wesley Pub. Co., publisher; Modem System Analysis and Design, by Jeffery A. Hoffer, et al., Second Edition, 1998, Addison-Wesley Pub. Co., publisher; Data Processing: Fundamentals, Design, and Implementation, by David M. Kroenke, Seventh Edition, 2000, Prentice Hall, publisher; Case Method: Entity Relationship Modelling (Computer Aided Systems Engineering), by Richard Barker, 1990, Addison-Wesley Pub Co., publisher.

All publications, patents and patent applications cited herein, whether above or below, are hereby incorporated by reference in their entirety.

Notwithstanding the foregoing, the database structure described herein, relative to the data contained and organized therein, is one of the features of the present invention. While the development and structuring of databases is well known, any acknowledgement herein of the conventional nature of database structures should not be construed as an acknowledgement that the database described herein, or any uses described for that database, are conventional.

It must be noted that, as used in this specification and the appended claims, the singular forms “a”, “an”, and “the” include plural referents unless the content clearly dictates otherwise. Thus, for example, reference to “a calibration phantom” includes one or more such phantoms.

1. Definitions

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, the preferred materials and methods are described herein.

The term “subject” encompasses any warm-blooded animal, particularly including a member of the class Mammalia such as, without limitation, humans and nonhuman primates such as chimpanzees and other apes and monkey species; farm animals such as cattle, sheep, pigs, goats and horses; domestic mammals such as dogs and cats; laboratory animals including rodents such as mice, rats and guinea pigs, and the like. The term does not denote a particular age or sex and, thus, includes adult and newborn subjects, whether male or female.

“Parameter” refers to an arbitrary constant or variable so appearing in a mathematical expression that changing it gives various cases of the phenomenon represented (McGraw-Hill Dictionary of Scientific and Technical Terms, S. P. Parker, ed., Fifth Edition, McGraw-Hill Inc., 1994). A parameter is any of a set of properties whose values determine the characteristics or behavior of something.

A “data point,” generally, is a numeric value which corresponds to a physical measurement (an “acquired” datum or data point) or to a single numeric result calculated or derived from one or more acquired data points (a “calculated” or “derived” datum or data point). Derived data include, but are not limited to, derived quantities from original data, such as, rate and/or magnitude of change, slope of a line (e.g., as determined by regression analysis), an intercept (e.g., as determined by regression analysis), and correlation coefficients. Data include but are not limited to numeric values derived using non-invasive or invasive tests providing anatomic, structural, physiological, biochemical, or biomechanical information on normal and pathological processes in a living body. Data include, for example, numeric values derived from x-rays or measurements of x-ray attenuation, computed tomography scans, ultrasound measurements including A-scan, B-scan, C-scan, compound scan, Doppler, 3D and 4D scans, positron emission computed tomography (PET), single photon emission computed tomography (SPECT), and magnetic resonance imaging or spectroscopy. Data include also numeric values derived with medical tests such as analysis of blood, urine, synovial fluid, cerebrospinal fluid, pericardial fluid, ascites and fluid in cavities. Data include also numeric values derived with medical tests such as cytology and histology. Data include also numerical values derived with use of invasive devices such as catheters. Data include also numeric values derived from analysis of medical photographic techniques, laser enhanced imaging, and various biomicroscopy techniques, using a range of color and spatial resolution, as well as a range of spectral components.

“Data tags,” also referred to as “attributes” of a data point, or “metadata,” are various characteristics of the particular data point with which they are associated. For example, data points comprising x-ray information (including bone mass, bone mineral density, or bone structure) are associated with a number of attributes, e.g., the date and time the image was taken; certain identification related to the particular subject from which the measurement was made (e.g., demographic information such as the particular subject's sex, age, race or address; physical characteristics such as height and weight; medical information, such as the medications used by the subject and/or type of disease suffered by the subject at present or in the past). For other types of data derived from other types of medical tests or images, the data points will correspond to values associated with the particular tests or images. Examples are provided more exhaustively below, but can include, merely as exemplary, cardiac, renal, ophthalmological, and/or dermatological data.

A “database” is a collection of data points and data attributes associated with each data point. Thus, a “data points, derived data, and data attributes database” is a database comprising data points collected, e.g. from an x-ray or other medical image or test, data derived from the original data points, and the data attributes associated with those data points or the derived data. A database may be limited to data points comprising measurements of one or more levels; those data points may further be collected from one or more subjects. For example, one data point database may be created and the information in the database related to a second database of attributes. Such combinations of one or more databases are within the skill of one of ordinary skill in the art in view of the teachings of the present specification. A “data warehouse” is another term for database. The term data warehouse is typically applied to large databases.

“Formulation” of a database comprises collecting data points, inputting those data points into a desired database format, and associating various attributes with each data point according to the particular format employed. A wide variety of software exists which provides a means for inputting data points, and associating the data points with data attributes, and include but are not imited to IBM DB2® (IBM Corporation), Excel® (Microsoft® Corporation, Seattle, Wash.) spreadsheet software, Quattro® (Corel Inc., Ottawa, Canada) spreadsheet software, Microsoft Access® (Microsoft) software, Oracle® (Oracle Inc., Redwood Shores, Calif.) software, as well as other database and data warehousing software.

“Manipulation” of a database refers to a variety of processes, e.g., selecting, sorting, sifting, aggregating, clustering, modeling, exploring, and segmenting data points using various data attributes or tags associated with the data points. Available systems for generating databases and manipulating the resulting databases include but are not limited to Sybase® (Sybase Systems, Emeryville, Calif.), Oracle® (Oracle Inc., Redwood Shores, Calif.), and Sagent Design Studio® (Sagent Technologies Inc., Mountain View, Calif.) systems software. Further, statistical packages and systems for data analysis and data mining are also available. Illustrative examples include SAS® (SAS Institute Inc., Cary, N.C.) and SPSS® (SPSS Inc., Chicago, Ill.) systems software.

“Data mining” refers to the process of selecting, exploiting, modeling, etc., large amounts of data to uncover previously unknown trends, patterns, and relationships within and among various data points and data attributes.

“Data aggregation” and “data clustering” refer to the process of grouping data points on the basis of one or more common attributes. Conversely, “data segmentation” refers to the process of differentiating data into discrete groups on the basis of one or more attributes.

“Transmitting remotely” refers to the process of sending medical images or data from a local site to a remote site. Medical images or data can be sent on electronic storage media via mail services or courier services. Medical images or data can also be sent with use of electronic transfer protocols from a local to a remote computer. Medical images or data can also be sent or shared with use of an electronic network connecting at least one or more local computers with at least one remote computer.

A network can be a local area network, or a more widespread network, such as a wide area network or a metropolitan area network. The Internet also might be considered a network of sorts for these purposes. Networks may be accessed through dial-up connections, network cards, digital subscriber lines (DSL), Integrated Services Digital Network (ISDN), T-1 lines, or other such connections. Some or all of these connection types may enable or permit Internet access, but it should be understood that networks are not limited to the Internet.

“Medical images” refer to any current or future imaging test to diagnose a disease process, to determine the severity of a disease process, to determine the prognosis of a patient, to monitor progression of a disease process, or to determine response to therapeutic intervention. Medical images can include x-rays, computed tomography (CT) scans, ultrasound, single x-ray absorptiometry scans, dual x-ray absorptiometry scans, positron emission computed tomography, single photon emission computed tomography, and magnetic resonance imaging (MRI) or spectroscopy, medical photography, optical coherence tomography, and confocal biomicroscopy.

A “standard x-ray image” refers to an x-ray image generated on standard x-ray equipment. A standard x-ray image can be obtained using conventional x-ray film. In this case, a standard x-ray image will typically be digitized using a scanner, video camera or other digitization device. A standard x-ray image can also be acquired digitally for example using phosphorus plate or amorphous silicon or selenium detector systems. A standard x-ray image also includes x-ray images acquired with computed radiography or digital radiography equipment. A standard x-ray image does not include data or images acquired using single or dual x-ray absorptiometry systems. A standard x-ray image can display various skeletal structures, including but not limited to one or more vertebra, a hip joint, a knee joint, an ankle joint, a foot, a calcaneus, an upper extremity, an elbow, a forearm, a distal radius, a wrist, a mandible, a tooth, or a maxilla.

“Standard x-ray equipment” refers to x-ray equipment that is used for general diagnostic purposes, e.g. assessment of arthritis, joint space narrowing, erosions, disc space narrowing, fractures, and others, evaluation of the chest and abdomen and others. Standard x-ray equipment includes typically a generator and a tube.

“Routine medical or dental care” refers to any care given by a medical or dental provider as part of routine medical or dental management. Said routine medical or dental care can be of a preventive or prophylactic nature; it can also be of a diagnostic or a therapeutic nature. Said routine medical care can be for treatment of a medical or dental condition. Said routine medical care can also be part of a standard semi-annual, annual, or bi-annual visit, or a visit at other time intervals, at the patient's or the medical or dental provider's request, without a precipitating medical or dental event. “Routine medical or dental care” excludes participation in clinical trials.

2. General Overview of the System

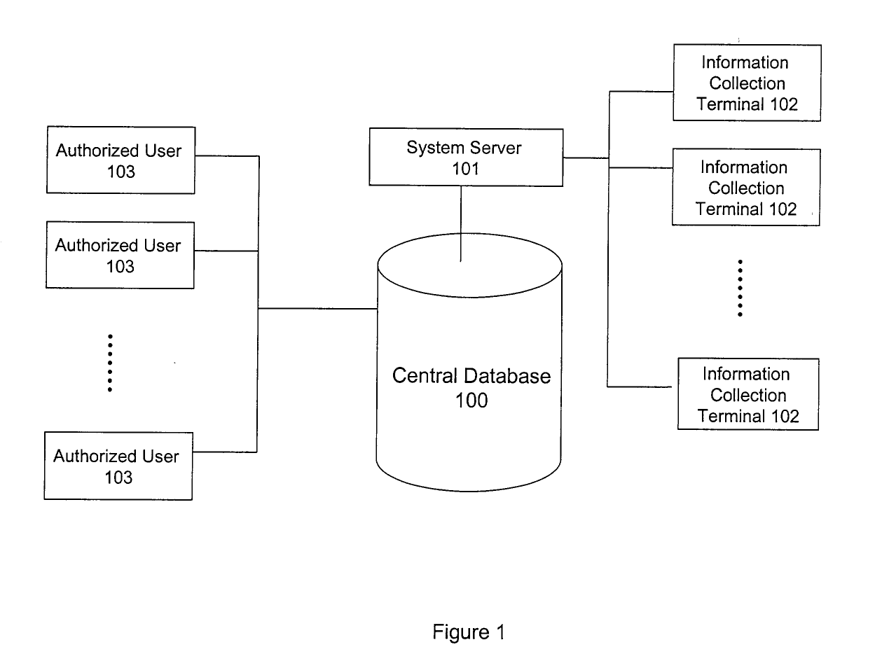

FIG. 1 illustrates an embodiment of the overall architecture of a system for building and manipulating a measurement value database of the present invention. A central database 100 of the system obtains information from numerous information collection terminals 102 through a system server 101, which is a remote computer system which may comprise one or a plurality of individual computers. The information collection terminals 102 may be any known data gathering and transmission system, including, by way of example and not limitation, desktop computers, notebook computers, embedded computers, handheld computers, personal digital assistants, or pocket PCs, either connected directly to an x-ray, other medical imaging system, or other medical diagnostic system, or capable of receiving or otherwise having information from such systems input thereinto for transmission to system server 101.

Authorized users 103 (corresponding in this embodiment to the number of information collection terminals, though of course the invention is not so limited) may access and manipulate the central database 100 via various kinds of networks, using any known variety of connections (from dial-up, to hard-wired connections, to wireless connections) to transfer data. The central database 100 can be stored in any suitable data storage medium, including hard disk storage, removable storage (including disk or tape storage), other magnetic, rewritable optical or magneto-optical storage, semiconductor memory (either volatile, with powered backup, or non-volatile), or bubble memory. The authorized users 103 can access the central database either directly or through the system server. The authorized users 103 can be individual physicians, dentists, larger healthcare providers, research institutes, government agencies, and drug manufacturers and their distribution networks, and organizations that maintain the central database, or staff members of any of the above mentioned entities.

The system server 101 receives information from the information collection terminals 102 which are authorized to transfer information into the central database 100 through the system server 101. In one embodiment, information collection terminals 102 can be any kind of device that can obtain relevant x-ray or other medical or dental images of a subject's tissue, and transfer the images, preferably in digital form, to the central database 100. One embodiment of the information collection terminals 102 comprises a dental x-ray machine and a computer system, though as noted above the terminals themselves may not be connected at all times to the x-ray or other medical imaging machine. Other types of medical information, not limited to medical or dental images, which may include other physical or physiological measurements, results of blood or other serological tests, and the like, also might be transmitted to the central database 100.

The computer system may comprise a standalone computer having one or more microprocessors, or a plurality of such computers, processing obtained x-ray (dental or medical x-rays, for example) or other medical images, or other kinds of measurements and test results as referred to above, and sending such images to the central database 100.

In another embodiment, the system has no central database. The information obtained by the information collection terminals is stored in a decentralized fashion in information storage modules, which can, for example, be integrated into the information collection terminals or be part of computer systems attached hereto. The information collection terminals or computer systems containing the information storage modules are connected to the same network, for example the Internet. For purposes of data mining, a request is sent by an authorized user over the network to all attached information storage modules to send the relevant data to the authorized user. The information storage modules return the requested information to the authorized user. This transfer of requests and information between the authorized user and the information storage modules over the network can be enabled by a peer-to-peer (P2P) network protocol. Examples for such P2P protocols are the distributed computing platform developed by Entropia, Inc. or the system used by the SETI@home project (http://setiathome.ssl.berkeley.edu).

In the following embodiments, the surveying of patients, and the obtaining of diagnostic and other medical and/or dental information from each of the following sources will be discussed: medical x-ray imaging; dental x-ray imaging; MRI; computed tomography (CT), PET, laboratory tests; ultrasound; self-tests; dermatological testing; and ophthalmic testing. The list of tests and images is not intended to be exhaustive, but rather is intended to be illustrative. The procedures generally to be followed to obtain and send the necessary information will be similar among these various imaging and testing regimens. However, as will be appreciated by those of working skill in this technological field, the diseases and drug efficacies which can be tracked can vary depending on the medical information source.

X-Ray Imaging

In one embodiment of the invention, when an x-ray image of a subject's bony structure such as a hip or spine is taken, an x-ray assistant or other staff member can enter into the system the subject's demographic information, such as age, gender, race, and address, and physical characteristic information, such as height and weight. In one embodiment, the x-ray assistant (or other staff member) could ask subjects some questions (e.g. yes or no questions) related to risk factors for certain diseases, e.g., bone related diseases such as osteoporosis or arthritis, to find out whether the subject has any of these risk factors. Such risk factors may include, but are not limited to:

Genetic

Family history of osteoporosis

Small body size

Hormonal

Late menarche (first menstrual period >15 years)

Prolonged amenorrhea (absence of menstruation)

Premature or surgical menopause

Hypogonadism

Lifestyle/Nutrition

Inadequate calcium intake

Smoking

Alcoholism/drinking habits

Eating disorders

Nulliparity (lack of childbearing)

Medical diseases

Hyperparathyroidism

Hyperthyroidism

Glucocorticoid excess

Malabsorption

Liver disease

Rheumatoid arthritis

Depression

These risk factors are adapted with permission from Luckey MM, author of Evaluation of Postmenopausal Osteoporosis, in Primer on the Metabolic Bone Diseases and Disorders of Mineral Metabolism, 4th edition, published by Lippincott Williams & Wilkins. The risk factors above obviously pertain particularly to osteoporosis. For other diseases which may be tracked in accordance with the invention, other or additional risk factor information may be relevant. As other risk factor information is identified for osteoporosis or other diseases for which the invention presently is believed to have particular applicability, such additional information can be gathered, and added to the central database 100.

The patient also can answer these questions, for example, on a web browser or by telephone. The telephone can use a voice recognition system, so that the patient is identified automatically. Alternatively, the patient can use buttons on a touchtone phone to enter identifying data, and even to answer the questions.

The answers to these questions will be entered into the central database 100 as a part of a subject's personal information. These risk factors can be used to normalize subjects' measurement values, to group subjects, and to identify areas with high population density of high risk patients.

The x-ray assistant or other staff member also can ask a subject whether he/she is currently taking any medication for the treatment of relevant diseases, e.g., osteoporosis, and if yes, which medication he/she is taking. The patient also can answer these questions in other ways, as described above.

X-rays of other skeletal areas include, by way of example, the forearm, upper arm, hand, wrist, lower leg, thigh, foot, ankle, knee joint, elbow joint, shoulder joint, ribs, and cranium. Of course, some of these areas may not be x-rayed as frequently. However, to the extent that it is possible to correlate bone data taken from different bones in the body, the use of x-rays of different skeletal areas can prove useful.

The x-ray images, preferably in digital form, together with the subject's treatment information and subject's personal information, which comprises the demographic information, past medical history, the physical characteristic information and the risk factors, then are transferred to a computer or a system server 101 for further processing.

A computer program can derive quantitative information from the x-ray images. Said quantitative information can, for example, be bone mass, bone mineral density or bone structure. The computer program deriving the quantitative information can be located on the information collection terminal or a computer attached to the information connection terminal. Alternatively, the computer program deriving the quantitative information can be located on a remote computer or a system server.

X-ray images can be acquired using conventional x-ray film. In that case, conventional x-ray film can be digitized using a standard digitizer or a video system. Alternatively, x-ray images can be acquired electronically, for example with use of known computed radiography techniques or with use of amorphous silicon or selenium detector systems.

At the information collection terminals 102, all information may be collected either via a paper-based system and digitized with an optical reader, or through a keyboard connected to the terminal. Alternatively, the data can be transferred from another computer. If the data is entered in a paper-based system, there is typically no immediate output. However, with digital input, the data may be displayed in a graphical user interface on a monitor at the terminal to be approved for accuracy. Once approved, the data is transmitted to the central database 100, or saved for later transfer.

The information collection terminal can be part of a Picture Archiving and Communication System.

In these embodiments, the collection of information through x-ray offices is believed advantageous for at least the following reasons. First, this approach is relatively inexpensive for service providers, because no new capital investment in x-ray or other medical imaging equipment is required. Instead, existing equipment at x-ray offices can be used. Second, gathering of such data at x-ray offices also is convenient to patients, because a patient can get his/her bone quality examined without undergoing any special procedures. While x-rays are not necessarily taken at every medical visit, patients undergoing treatment for bone-related diseases or disorders may have medical images taken at relatively regular intervals. However, it should be understood that the present invention is not intended to be limited to retrieval of information from x-rays. Alternatively, the information can also be collected from the office of any medical practitioner who provides periodic tests for certain tissues, organs or disease processes, including the taking of x-rays or other medical images or other medical tests.

The system server 101 can extract quantitative information from the x-ray images such as bone mineral density or other parameters reflecting bone health or bone structure, processes subjects' personal information and treatment information from the information collection terminals 102, and stores the resulting data in the central database 100 to allow the authorized users to perform statistical analysis. The processing and storage of the information will be explained in detail below. Representative examples for the extraction of relevant quantitative information from the images are described in detail in the foregoing identified U.S. patent applications, and also in U.S. patent application Ser. No. 09/977,012, filed Oct. 12, 2001, and entitled METHODS AND DEVICES FOR ANALYSIS OF X-RAY IMAGES, also incorporated by reference herein. Alternatively, the information collection terminals or computers attached to the information collection terminals can extract quantitative information from the x-ray images such as bone mineral density or other parameters reflecting bone health or bone structure,

A user can obtain authorization to access the central database 100 via his/her computer system via traditional user authorization technology, e.g., login ID and password. The authorized user can input a query and perform statistical analysis of the stored data from various viewpoints. The query could be, for example, a subject's bone mass, bone mineral density bone structure, or other bone characteristic changes over time; prevalence of the disease of interest in a specific geographic region; identification of areas with a high prevalence of high risk or low risk individuals; market shares of several drugs used for treatment of the disease of interest; information useful for targeted marketing; the efficacy of different drugs; and other similar types of information. Of course, for different types of disease, which may or may not be bone-related, other types of queries may be appropriate. Various disease examples are described herein, and the invention is considered applicable to queries relevant to those disease or disorder examples, and corresponding medical information taken that pertain to such disease or disorder examples.

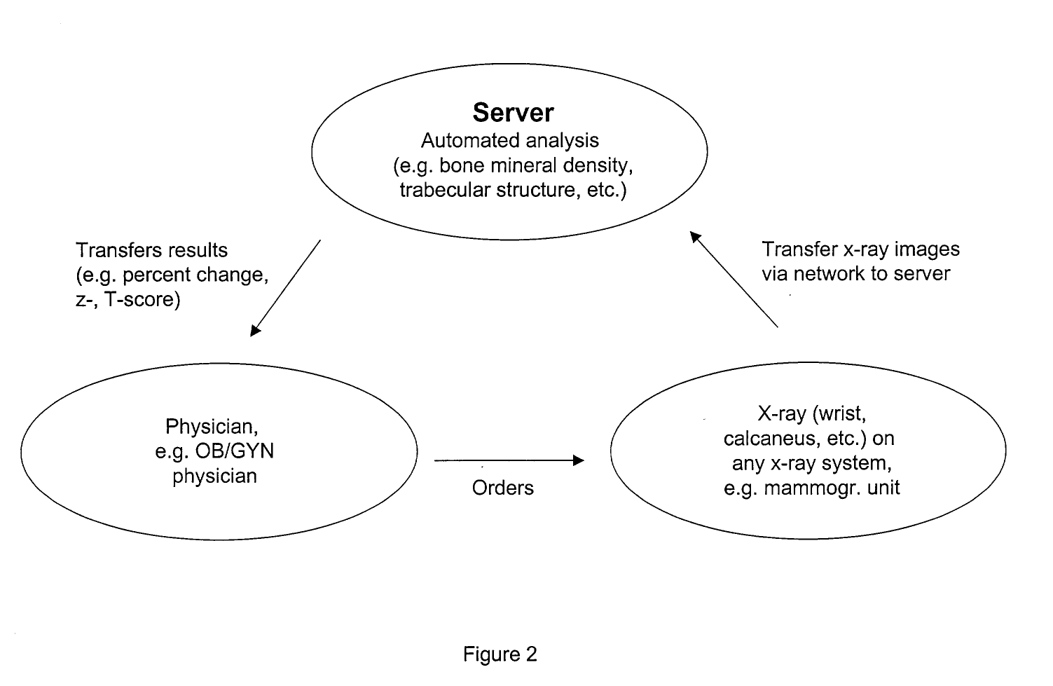

FIG. 2 illustrates an example of network enabled quantitative x-ray analysis useful in monitoring a disease of interest, such as osteoporosis or arthritis. The system server 101 analyzes the received x-ray images, generates a diagnostic report, and transfers the report to a medical provider, e.g. a physician, who can, in turn, communicate the diagnostic result to the subject. Such reports can be generated using computer programs, for example programs on the system server 101. The diagnostic report can include, for example, information on a subject's state of health (e.g, bone mineral density status such as osteoporosis and/or information on fracture risk). Other disease states can also be analyzed from medical images or data derived with medical tests using the teachings described herein.

Dental X-Rays

In another embodiment of the invention, when a dental x-ray image is taken, a dental assistant can enter into the system the subject's demographic information, as described above with respect to the medical x-ray example. It should be noted that, while dental x-rays can be used to obtain various types of bone-related information which would be relevant to diagnosis of disease, other diseases, for example periodontal disease, can be tracked, and additional information can be gathered, and added to the central database 100. The process corresponds generally to the one described above relative to medical x-rays. However, in addition, dental diseases, such as periodontal and other oral and dental-related diseases, can be tracked, and therapy efficacy tracked.

In this embodiment, the collection of information through dental offices is believed advantageous for at least the following reasons. First, this approach is relatively inexpensive for service providers, because no new capital investment in x-ray or other medical imaging equipment is required. Instead, existing equipment at dental offices can be used, and virtually every dental office will have such imaging equipment. Second, gathering of such data at dental offices also is convenient to patients, because a patient can get his/her bone quality examined when visiting dentists, without undergoing a special procedures, because dental x-rays are taken routinely during periodic visits to the dentist. While x-rays are not taken at every dental visit, dental visits tend to be periodic, and x-rays thus will tend to be taken on some kind of periodic basis, as a part of regular dental care. However, it should be understood that the present invention is not intended to be limited to retrieval of information from dental x-rays, or from dentists per se. Alternatively, the information can also be collected from the office of any medical practitioner who provides periodic tests for certain tissue, organs, or disease processes, including the taking of x-rays or other medical images or other medical tests.

The analysis depicted in FIG. 2 is equally applicable to the dental image embodiment, and to other imaging-based or testing-based embodiments described herein.

MRI

In another embodiment of the invention, when a magnetic resonance imaging (MRI) image, for example including an articular structure such as a hip or knee is taken, an MRI assistant can enter into the system the subject's demographic information, such as age, gender, race, and address, and physical characteristic information, such as height and weight. In one embodiment, the MRI assistant (or other staff member) could ask subjects some questions (e.g. yes or no questions) related to risk factors for certain diseases, e.g., bone related diseases such as osteoporosis or arthritis, to find out whether the subject has any of these risk factors. Such risk factors may include, but are not limited to:

Genetic

Family history of osteoporosis of arthritis

Past Medical History

Prior injuries

Prior fractures

Prior surgeries

Clinical information, for example provided by an orthopedic surgeon or physician assistant

Anterior drawer sign

Positive meniscal signs

Crepitus

The risk factors above obviously pertain particularly to osteoarthritis, which is used here merely as one example of a disease to which the present invention may be applied. For other diseases which may be tracked in accordance with the invention, other or additional risk factor information may be relevant. For example, information pertaining to risk factors for osteoporosis was discussed above. As other risk factor information is identified for osteoarthritis or other diseases for which the invention presently is believed to have particular applicability, such additional information can be gathered, and added to the central database 100.

In this embodiment, the collection of information through MRI offices is believed advantageous for at least the following reasons. First, this approach is relatively inexpensive for service providers, because no new capital investment in MRI or other medical imaging equipment is required. Instead, existing equipment at MRI offices can be used. Second, gathering of such data at MRI offices also is convenient to patients, because a patient can get his/her bone or cartilage quality examined without undergoing special procedures. While MRIs are not necessarily taken at every medical visit, they still may be taken periodically by health care officials monitoring a patient's progress, either in recovery, or through a treatment regimen. However, it should be understood that the present invention is not intended to be limited to retrieval of information from MRIs. Alternatively, the information can also be collected from the office of any medical practitioner who provides periodic tests for certain tissues, organs or disease processes, including the taking of x-rays or other medical images or other medical tests.

A computer or a system server 101 extracts quantitative information from the MRI images such as cartilage volume or cartilage thickness or other parameters reflecting cartilage or bone health, processes subjects' personal information and treatment information from the information collection terminals, and stores the resulting data in the central database 100 to allow the authorized users to perform statistical analysis. The processing and storage of the information will be explained in detail below. Representative examples of the extraction of relevant quantitative information from the images are described in detail in the foregoing identified U.S. patent applications, and also in the following U.S. patent application:

I. U.S. patent application Ser. No. 09/882,363, entitled: “ASSESSING THE CONDITION OF A JOINT AND PREVENTING DAMAGE”;

II. U.S. patent application Ser. No. 09/953,531, entitled: “NEW TECHNIQUES FOR MANIPULATING MEDICAL IMAGES”;

III. U.S. patent application Ser. No. 09/662,224, entitled: “ASSESSING THE CONDITION OF A JOINT AND DEVISING TREATMENT”;

IV. U.S. patent application Ser. No. 09/953,373, entitled: “ASSESSING THE CONDITION OF A JOINT AND ASSESSING CARTILAGE LOSS”;

V. U.S. Provisional Patent Application No. 60/112,989, entitled: “A METHOD FOR QUANTIFYING AND MODELING DYNAMIC TISSUE CONDITIONS”.

The contents of these applications also are incorporated by reference herein.

The quantitative information-can also be derived using the information collection terminal 102 or a computer attached to the information collection terminal 102.

A user can obtain authorization to access the central database 100 via his/her computer system via traditional user authorization technology, e.g., login ID and password. The authorized user can input a query and perform statistical analysis of the stored data from various viewpoints. The query could be, for example, a subject's cartilage changes over time; prevalence of the disease of interest in a specific geographic region identification of areas with a high prevalence of high risk or low risk individuals; market shares of several drugs used for treatment of the disease of interest; information useful for targeted marketing; the efficacy of different drugs, etc.

Diagnostic reports can be generated using computer programs, for example programs on the system server 101. The diagnostic report can include, for example, information on a subject's state of health (e.g, cartilage status such as thickness and/or information on glycosaminoglycan content). Other disease states can also be analyzed from medical images or data derived with medical tests using the teachings described herein.

The analysis depicted in FIG. 2 is equally applicable in this embodiment.

It also should be noted that, while not described herein in quite the same level of detail, the invention is equally applicable to computed tomography (CT) scans, and also to PET and other scans mentioned herein. The foregoing description of medical and dental x-rays and other images, and MRI, will indicate to the ordinarily skilled artisan that the invention contemplates the suitability of the invention for tracking patient conditions and treatment regimens and efficacies for diseases and disorders for which relevant information can be derived from CT, PET, and other scans.

Laboratory Tests

In another embodiment of the invention, when a laboratory test, for example, a blood test for heart disease is performed, a laboratory assistant can enter into the system the subject's demographic information; such as age, gender, race, and address, and physical characteristic information, such as height and weight. In one embodiment, the laboratory assistant (or other staff member) can ask subjects some questions (e.g. yes or no questions) related to risk factors for certain diseases, e.g., heart disease, stroke, renal disease or diabetes, to find out whether the subject has any of these risk factors.

The laboratory assistant can also ask the subject whether he/she is currently taking any medication for the treatment of relevant diseases, e.g., osteoporosis, arthritis, heart disease, stroke, renal disease, or diabetes, and if yes, which medication he/she is taking. The laboratory assistant can also ask which dose the patient is taking.

Other laboratory tests for which data may be used for diagnostic, efficacy determination, or market penetration determination purposes in accordance with the invention may include liver tests, renal tests, tests for diabetes, electrocardiograms EKGs), electroencephalograms (EEGs), heart disease tests, blood pressure tests, holesterol tests, and tests for enzyme changes.

The laboratory test results are handled in a manner similar to the medical and dental x-ray results, MRI, etc.

A user can obtain authorization to access the central database 100 via his/her computer system via traditional user authorization technology, e.g., login ID and password. The authorized user can input a query and perform statistical analysis of the stored data from various viewpoints. The query could be, for example, a subject's enzyme levels or changes reflective of heart disease or biomarker levels reflective of osteoporosis over time; prevalence of the disease of interest in a specific geographic region; identification of areas with a high prevalence of high risk or low risk individuals; market shares of several drugs used for treatment of the disease of interest; information useful for targeted marketing; the efficacy of different drugs, and the like.

Diagnostic reports can be generated using computer programs, for example programs on the system server 101. The diagnostic report can include, for example, information on a subject's state of health (e.g, cardiac or renal function status).

The analysis depicted in FIG. 2 is equally applicable in this embodiment.

Ultrasound

In another embodiment of the invention, when a quantitative ultrasound test is performed, for example, for assessing cardiac function or vascular flow states or body composition or osteoporosis, an ultrasound assistant can enter into the system the subject's demographic information, such as age, gender, race, and address, and physical characteristic information, such as height and weight. In one embodiment, the ultrasound assistant (or other staff member) can ask subjects some questions (e.g. yes or no questions) related to risk factors for certain diseases, e.g., osteoporosis, arthritis, heart disease, stroke, renal disease, or diabetes, to find out whether the subject has any of these risk factors.

The ultrasound test results are handled in a manner similar to the medical and dental x-ray results, MRI, laboratory test results, etc. A computer or a system server 101 extracts quantitative information from the ultrasound images, ultrasound data or ultrasound analyses such as Doppler flow, tissue echogenicity, broadband ultrasound attenuation, speed of sound or other parameters reflecting physiologic and disease states, processes subjects' personal information and treatment information from the information collection terminals, and stores the resulting data in the central database 100 to allow the authorized users to perform statistical analysis. Alternatively, the ultrasound device or the information collection terminal or a computer attached to the ultrasound device or the information collection terminal can derive portions or all of the quantitative information. The processing and storage of the information will be explained in detail below.

A user can obtain authorization to access the central database 100 via his/her computer system via traditional user authorization technology, e.g., login ID and password. The authorized user can input a query and perform statistical analysis of the stored data from various viewpoints. The query could be, for example, a subject's ultrasound data reflective of osteoporosis; prevalence of the disease of interest in a specific geographic region; identification of areas with a high prevalence of high risk or low risk individuals; market shares of several drugs used for treatment of the disease of interest; information useful for targeted marketing; the efficacy of different drugs, etc.

Diagnostic reports can be generated using computer programs, for example programs on the system server 101. The diagnostic report can include, for example, information on a subject's state of health (e.g, cardiac or renal function status).

The analysis depicted in FIG. 2 is equally applicable in this embodiment.

Self Tests

In another embodiment of the invention, a patient may perform a self-test, for example, for assessing cardiac function using an EKG, or for diabetes using a blood sugar monitoring device. The patient can enter into the system his or her demographic information, such as age, gender, race, and address, and physical characteristic information, such as height and weight. In one embodiment, the patient can answer some questions (e.g. yes or no questions) related to risk factors for certain diseases, e.g., osteoporosis, arthritis, heart disease, stroke, renal disease, or diabetes, to find out whether the patient has any of these risk factors. These questions can, for example, be administered on a web browser. In another embodiment, a physician's assistant or other staff member may ask such questions to the patient and create a patient profile in this fashion.

The data obtained as just described would be handled in a manner similar to that described above with respect to the other embodiments. The answers to the questions will be entered into the central database 100 as a part of a patient's personal information. These risk factors can be used to normalize patients'0 measurement values, to group subjects, and to identify areas with high population density of high risk patients.

The test results, preferably in digital form, for example an EKG or a blood glucose level, together with the patient's treatment information and patient's personal information, which comprises the demographic information, the physical characteristic information, past medical history and the risk factors, is then transferred to the system server 101 for further processing.

A computer or a system server 101 extracts quantitative information from the self-test reflecting physiologic and disease states, processes subjects' personal information and treatment information from the information collection terminals 102, and stores the resulting data in the central database 100 to allow the authorized users to perform statistical analysis. Alternatively, the information collection terminal or a computer attached to the information collection terminal can derive portions or all of the quantitative information. The processing and storage of the information will be explained in detail below.

A user such as the patient or a physician can obtain authorization to access the central database 100 via his/her computer system via traditional user authorization technology, e.g., login ID and password. The authorized user can input a query and perform statistical analysis of the stored data from various viewpoints. The query could be, for example, a subject's EKG changes reflective of heart disease or blood glucose levels reflective of diabetes over time; prevalence of the disease of interest in a specific geographic region; identification of areas with a high prevalence of high risk or low risk individuals; market shares of several drugs used for treatment of the disease of interest; information useful for targeted marketing; the efficacy of different drugs, and the like.

Diagnostic reports can be generated using computer programs, for example programs on the system server 101. The diagnostic report can include, for example, information on a subject's state of health (e.g, cardiac or renal function status).

The analysis depicted in FIG. 2 is equally applicable in this embodiment.

Diagnostic Probes

In another embodiment of the invention, a diagnostic probe can be applied to a patient's body surface or inside a patient, for example, for assessing cardiac function. The diagnostic probe generates raw data, for example, on physiologic parameters of heart function. A physician assistant or other staff member can enter into the system the subject's demographic information, such as age, gender, race, and address, and physical characteristic information, such as height and weight.

The data obtained as just described would be handled in a manner similar to that described above with respect to the other embodiments. The answers to the above questions may be entered into the central database 100 as a part of a subject's personal information. These risk factors can be used to normalize subjects' measurement values, to group subjects, and to identify areas with high population density of high risk patients.

A user can obtain authorization to access the central database 100 via his/her computer system via traditional user authorization technology, e.g., login ID and password. The authorized user can input a query and perform statistical analysis of the stored data from various viewpoints. The query could be, for example, a subject's changes in cardiac output over time; prevalence of the disease of interest in a specific geographic region; identification of areas with a high prevalence of high risk or low risk individuals; market shares of several drugs used for treatment of the disease of interest; information useful for targeted marketing; the efficacy of different drugs, etc.

Diagnostic reports can be generated using computer programs, for example programs on the system server 101. The diagnostic report can include, for example, information on a subject's state of health (e.g, cardiac or renal function status).

The analysis depicted in FIG. 2 is equally applicable in this embodiment.

Dermatologic Disorder

In another embodiment of the invention, a photographically derived medical image can be obtained from a patient's body surface, for example, for assessing dermatologic disease, course of the disease over time, and/or response to therapy. The dermatologic image generates raw data, for example, on status of dermatitis or melanocytic nevi. A physician assistant can enter into the system the subject's demographic information, such as age, gender, race, and address, and physical characteristic information, such as height and weight.

The data obtained as just described would be handled in a manner similar to that described above with respect to the other embodiments. The answers to the questions may be entered into the central database 100 as a part of a patient's personal information. These risk factors can be used to normalize patients' measurement values, to group subjects, and to identify areas with high population density of high risk patients.

A user can obtain authorization to access the central database 100 via his/her computer system via traditional user authorization technology, e.g., login ID and password. The authorized user can input a query and perform statistical analysis of the stored data from various viewpoints. The query could be, for example, a subject's changes in melanocytic nevi distribution over their upper torso over time; prevalence of the disease of interest in a specific geographic region; identification of areas with a high prevalence of high risk or low risk individuals; market shares of several drugs used for treatment of the disease of interest; information useful for targeted marketing; the efficacy of different drugs, etc.

A diagnostic report can be generated using computer programs, for example programs on the system server 101. The diagnostic report can include, for example, information on a subject's state of health (e.g, status of dermatitis or other dermatological conditions).

The analysis depicted in FIG. 2 is equally applicable in this embodiment.

Ophthalmic Disorder

In another embodiment of the invention, a photographically, biomicroscopically, laser enhanced, optical coherent tomographically, or confocally derived medical image can be obtained from a patient's ocular surface, anterior segment, or posterior segment including, for example, optic nerve head, or retina, for assessing ophthalmic disorders such as glaucoma or diabetic retinopathy, monitor the course of the disease over time, and/or response to therapy. The medical images may be derived using tomographic techniques, including ultrasound or optical coherence tomography, using apparatus known to ordinarily skilled artisans. The ophthalmic image generates raw data for example on status of optic nerve head nerve fiber layer, or degree, nature, and morphology of retinal vascular abnormalities. A physician assistant can enter into the system the subject's demographic information, such as age, gender, race, and address, and physical characteristic information, such as height and weight. The procedure for acquiring and sending data otherwise corresponds generally to what has been described in greater detail above with respect to the other embodiments.

The data obtained as just described would be handled in a manner similar to that described above with respect to the other embodiments. The answers to the questions may be entered into the central database 100 as a part of a patient's personal information. These risk factors can be used to normalize patients' measurement values, to group subjects, and to identify areas with high population density of high risk patients.

A user can obtain authorization to access the central database 100 via his/her computer system via traditional user authorization technology, e.g., login ID and password. The authorized user can input a query and perform statistical analysis of the stored data from various viewpoints. The query could be, for example, a subject's changes in optic nerve head cup to disc ratio; prevalence of the disease of interest in a specific geographic region; identification of areas with a high prevalence of high risk or low risk individuals; market shares of several drugs used for treatment of the disease of interest; information useful for targeted marketing; the efficacy of different drugs, etc.

A diagnostic report can be generated using computer programs, for example programs on the system server 101. The diagnostic report can include, for example, information on a subject's state of ophthalmic health (e.g, status of glaucoma or ophthalmic condition).

The analysis depicted in FIG. 2 is equally applicable in this embodiment.

Biometric Application

The ability to positively identify and authenticate an individual has far reaching implications for reasons of both security and confidentiality. Typically, for the highest level of security, experts may validate identities based on what an individual knows (username and password), what they have (hardware enabled validation systems), and what they are (image analysis). This application of the present invention supports the highest level of identification by capturing biological data over time. This database can contain quantitative imaging data that can be used to make biometric matches (with parameters extracted for this application being optimized for biometrics). In addition, because of the therapeutic and demographic data captured, identities are determined more precisely by applying a multi-parametric analysis of what the individual knows about their history in addition to what their imaging data reveals regarding their probable identity. For example, medical images of retinal vascular patterns, facial images, iris structure, patterns of teeth on dental x-rays, are all potential parameters of biometric interest. Patterns on dental x-rays can include, but are not limited to shape of one or more teeth, shape of crowns, presence, shape or absence of cavities, presence, location or absence of periodontal disease, bone structure, etc.

In another embodiment, posthumous identification of individuals can also be accomplished using these same techniques of biometrics, applied to forensic medicine.

In addition, because of the temporal nature of the database, multiple images from the same individual may be obtained at different times, often separated by months or years. Therefore, the system can also be a predictive tool for statistically defining the normal amount of change to expect in any particular biometric parameter chosen over any designated time period for an individual based on the changes in that parameter measured by a demographically matched reference of the database. Since there is some change in biometric parameters with time, this database can then be the reference database to, improve accuracy of any biometric system that depends on analysis of biometrically relevant biological image parameters, whether applied to authentication or forensic identification.

3. Hardware/Software and System Considerations

a. Hardware/Software

Various computer systems, typically comprising one or more microprocessors, can be used to transfer, store, retrieve, and analyze information obtained according to the methods described herein. The computer system can be as simple as a stand-alone computer that is not networked to other computers, provided the system has a form of data storage, for example disk drives, removable disk storage, for example ZIP® drives (Tomega Corporation, Roy, Utah), optical medium (e.g., CD-ROM), magnetic tape, solid-state memory, and/or bubble memory. Alternatively, the computer system can include a networked computer system in which a computer is linked to one or more additional computers, for example a network server. The networked system can be an Intranet system and/or a system linked to other computers via the Internet. Thus, the computer systems can be Internet-based systems or non-Internet based systems. The networks can be wired or wireless. Also, connection to a network may be achieved via dial-up or other access, whether over the Internet or directly to system server 101.

In addition, devices such as Personal Digital Assistants (PDA), for example those made by Palm Inc., Santa Clara, Calif. or Handspring, Inc., Mountain View, Calif. and Pocket PCs (PPC), for example those made by Casio Inc., Dover, N.J. or Compaq Computer Corporation, Houston, Tex. can be used to transfer, store and retrieve patient database information. The PDA or PPC can be a simple stand-alone device that is not networked to other computers, provided the device has a form of data storage, for example solid-state memory, SD (secure digital) and MMC (multimedia card) cards. Alternatively, the PDA or PPC can be attached to a network in which the unit is linked to one or more computers, for example a network server or PC. The networked PDA or PPC can be an intranet system and/or a system linked to computers via the Internet. Thus, the PDA or PPC systems can be Internet attached systems or non-Internet attached systems.

For example, information regarding x-ray or other radiographic images and the parameters that were used to acquire the images (e.g., acquisition parameters) can be transmitted with the images over a local or long-distance network. The image acquisition parameters can be transmitted simultaneously with the image or before or after the image transmission over the network. Image acquisition parameters that can be transmitted in this fashion include but are not limited to x-ray tube voltage settings, energy settings, x-ray tube current, film-focus distance, object-film distance, collimation, focal spot, spatial resolution, filter settings, computed or digital radiography settings, etc. These parameters can be entered manually into a data registration sheet or database that can be transmitted before, after or simultaneously with the images. Alternatively, at least some of these parameters can be transmitted automatically, while others that may be kept constant between different subjects can be stored either at the local site or on the network.

Thus, transmission of the acquisition parameters before, after or simultaneously with an image over the network can be used to improve the accuracy of quantitative measurements from the image. For example, information on the density of an anatomic structure or a non-living object included on the image can be derived more accurately, when the image acquisition parameters are known.

Similar protocols apply to MRI, CT, PET, or other types of images or scans, as would be apparent to ordinarily skilled artisans.

According to another embodiment, information regarding ultrasound data and the parameters that were used to acquire the ultrasound data (e.g., acquisition parameters) can be transmitted with the ultrasound data over a local or long-distance network. The ultrasound data acquisition parameters can be transmitted simultaneously with the ultrasound data or before or after the ultrasound data transmission over the network. Ultrasound data acquisition parameters that can be transmitted in this fashion include but are not limited to one or more of transducer frequency, depth information, transmit and receive gain information, or Doppler angle information.

These parameters can be entered manually into a data registration sheet or database that can be transmitted before, after or simultaneously with the ultrasound data. Alternatively, at least some of these parameters can be transmitted automatically, while others that may be kept constant between different subjects can be stored either at the local site or on the network.

Thus, transmission of the ultrasound data acquisition parameters before, after or simultaneously with the ultrasound data over the network can be used to improve the accuracy of quantitative measurements from ultrasound. For example, information on the composition of an anatomic structure or a non-living object included on an ultrasound image can be derived more accurately, when the ultrasound data acquisition parameters are known.

In yet another embodiment, information regarding various medical tests such as the ones mentioned above, and the parameters that were used to perform those tests (e.g., acquisition parameters) can be transmitted with the test data or test results over a local or long-distance network. The acquisition parameters can be transmitted simultaneously with the test data or test results or before or after the test data or test result transmission over the network. The acquisition parameters can be entered manually into a data registration sheet or database that can be transmitted before, after or simultaneously with the test data or test results. Alternatively, at least some of these parameters can be transmitted automatically, while others that may be kept constant between different subjects can be stored either at the local site or on the network.

Transmission of the acquisition parameters before, after or simultaneously with the test data or test results over the network can be used to improve the accuracy of quantitative measurements from the test data or test results.

Similar considerations apply to each of the types of tests and imaging techniques described in detail earlier.

The software can be installed in a PC, a Silicon Graphics, Inc. (SGI) computer, a Sun workstation, a Macintosh computer, or other computer system.

b. Stand-alone System

Connection to a central network (erg., the Internet) can be made either directly, or via serial interface adapter. For example, a direct connection could be made if the readout device has wireless capability; alternatively, a connection through a SIA or other sort of docking station between the device and the network.

In some instances, a computer system includes a computer having an Intel Pentium® microprocessor (Intel Corporation, Santa Clara, Calif.) that runs any of the Microsoft Windows® operating systems, such as Microsoft WINDOWS® Version 3.1, WINDOWS95®, WINDOWS98®, WINDOWS NT®, WINDOWS 2000®, or Windows XP® (Microsoft Corporation, Redmond, Wash.). Of course other microprocessors such as the ATHLON™ microprocessor (Advanced Micro Devices, Inc., Sunnyvale, Calif.) and the Intel® CELERON® and XEON® microprocessors can be utilized. Other computer systems, such as Apple, Sun, and Silicon Graphics, may operate with other types of processors, including but not limited to the PowerPC® processor, and various flavors of RISC (reduced instruction set computer) processors. The methods and systems can also include other operating systems, for example, UNIX, LINUX, Apple MAC OS 9 and OS X (Apple, Cupertino, Calif.), PalmOS® (Palm Inc., Santa Clara, Calif.), Windows® CE 2.0 or Windows® CE Professional (Microsoft Corporation, Redmond, Wash.) without departing from the scope of the present invention. Future or enhanced versions of these operating systems also may be used. Also typically included is the storage media, for example disk drive, removable disk storage, or writable or rewritable CD-ROM or other magnetic, optical or magneto-optical storage, required to store and retrieve subject database information.

Communication with a computer system can be achieved using a standard computer interface, for example a serial interface, Universal Serial Bus (USB) port, FireWire or fibre channel interface. Standard wireless interfaces, for example radio frequency (RF) technology—IEEE 802.11 and Bluetooth, and/or infrared technologies can also be used. The data can be encoded in the standard manner, for example American Standard Code for Information Interchange (ASCII) format—a standard seven-bit code that was proposed by ANSI in 1963, and finalized in 1968. ASCII is the common code for microcomputer equipment.

The computer system can store the information, for example into a database, using a wide variety of existing software that provides a means for inputting data points, and associating the data points with data attributes. Available systems for generating databases and manipulating the resulting databases include but are not limited to Excel® (Microsoft® Corporation, Seattle, Wash.) spreadsheet software, Quattro® (Corel Inc., Ottawa, Canada), Sybase® (Sybase Systems, Emeryville, Calif.), Microsoft Access® (Microsoft) software, Oracle® (Oracle Inc., Redwood Shores, Calif.), and Sagent Design Studio® (Sagent Technologies Inc., Mountain View, Calif.) systems software. Further, statistical packages and systems for data analysis and data mining are also available (see below). Illustrative examples include but are not limited to SAS® (SAS Institute Inc., Cary, N.C.) and SPSS® (SPSS Inc., Chicago, Ill.). The database can be recorded on, for example a disk drive—internal or external to the system, a Read/Write CD-ROM drive, a tape storage system, solid-state memory or bubble memory, an SD or MMC. In addition to saving the data in a database, the information can be forwarded to an auxiliary readout device such as a display monitor.

c. Networked System

Networked computer systems are also suitable for performing the methods of the present invention. A number of network systems can be used, for example a local area network (LAN) or a wide area network (WAN). A networked computer system can include the necessary functionality for forwarding the data in established formats, for example Ethernet or Token Ring Packets or Frames, HTML-formatted data, or WAN digital or analog protocols, in combination with any parameter information, for example Destination Address, or Cyclic Redundancy Check (CRC). CRC is a powerful and easily implemented technique to obtain data reliability. The CRC technique is used to protect blocks of data called Frames. Using this technique, the transmitter appends an extra n-bit sequence to every frame called Frame Check Sequence (FCS). The FCS holds redundant information about the frame that helps the transmitter detect errors in the frame. CRC is one of the most used techniques for error detection in data communications into a format suitable for transmission across a transmission line for delivery to a database server. Further, the networked system may comprise the necessary software and hardware to receive the data from the readout device, store the data, process the data, display the data in a variety of ways, and communicate back to the readout device as well as to allow communication among a variety of users and between these users to the readout device.

The networked computer system, for example an Ethernet, Token Ring or FDDI network, can be accessed using a standard network interface card (NIC), for example a 3Com® EtherLink® NIC (3Com, Inc, Santa Clara, Calif.) which provide network connections over UTP, coaxial, or fiber-optic cabling or an Intel® PRO/100 S Desktop Adapter (Intel Corporation, Santa Clara, Calif.) or using a standard remote access technology, for example a modem using a plain old telephone system (POTS) line, Integrated Services Digital Network (ISDN), a xDSL router connected to a digital subscriber line (DSL), or a cable modem. Additionally, the networked computer system can be connected to the LAN using a standard wireless interface, for example radio frequency (RF) technology—IEEE 802.11 and Bluetooth.

The networked computer system would have the same capability of storing data, as the stand-alone system, onto a storage media, for example a disk drive, tape storage, or CD-ROM. Alternatively, the networked computer system can transfer data to any device connected to the networked computer system, for example at a medical doctor or medical care facility using standard e-mail software, a central database using database query and update software (e.g., a data warehouse of data points, derived data, and data attributes obtained from a large number of subjects). Alternatively, a user could gain access from a doctor's office or medical facility, using any computer system with Internet access, to review historical data that may be useful for determining treatment.

If the networked computer system includes a World Wide Web application, the application may include the executable code required to generate database language statements, for example, SQL statements. Such executables typically include embedded SQL statements. The application further includes a configuration file that contains pointers and addresses to the various software entities that are located on the database server in addition to the different external and internal databases that are accessed in response to a user request. The configuration file also directs requests for database server resources to the appropriate hardware, as may be necessary if the database server is distributed over two or more different computers.

Each networked computer system can include a World Wide Web or other Internet browser that provides a user interface to the networked database server. The networked computer system may be able to construct search requests for retrieving information from a database via a browser. With access to such a browser, users can typically point and click to user interface elements such as buttons, pull down menus, and other graphical user interface elements to prepare and submit a query that extracts the relevant information from the database. Requests formulated in this manner are subsequently transmitted to the Web application that formats the requests to produce a query that can be used to extract the relevant information from the database.

When Web-based applications are utilized, the Web application accesses data from a database by constructing a query in a database language such as Sybase or Oracle SQL which is then transferred to a relational database management system that in turn processes the query to obtain the pertinent information from the database.

Accordingly, in one aspect the present invention describes a method of providing data on x-ray images, ultrasound, CT scans, nuclear scintigraphy, SPECT scans, PET scans, MRI scans, MRI spectroscopy, histologic images, cytology images, other medical images including photographic images or other medical test on a network, for example the Internet, and methods of using this connection to provide real-time and delayed data analysis. The central network can also allow access by the physician to a subject's data. Similarly, an alert could be sent to the physician if a subject's readings are out of a predetermined range, etc. The physician can then send advice back to the patient via e-mail or a message on a web page interface. Further, access to the entire database of data from all subjects may be useful to the statistical or research purposes. Appropriate network security features (e.g., for data transfer, inquiries, device updates, etc.) are of course employed.

Further, a remote computer, such as the system server 101, can be used to analyze the x-ray, ultrasound, CT scan, nuclear scintigraphy scan, SPECT scan, PET scan, MRI scan, histologic scan, cytology scan, medical image or other medical test that has been transmitted over the network automatically. For example, x-ray density information or structural information about an object can be generated in this fashion. X-ray density information can include, for example, bone mineral density. If used in this fashion, the test can be used to diagnose osteoporosis (see FIG. 2). X-ray structural information can include, for example, trabecular spacing or trabecular orientation. MRI information can include, for example, cartilage thickness or volume or thickness or volume of a tumor or other lesion. MRI information can also include relaxation time, contrast enhancement, and others. Ultrasound information can include tissue thickness, echogenicity, vascular flow, broadband ultrasound attenuation, speed of sound, and others. Ophthalmologic information can include, for example, information derived from microscopy and confocal microscopy, laser enhanced imaging, as well as photographic information, varying in both color resolution and electromagnetic spectrum, with or without intravenous enhancing dye, and can be based on structural analysis of anterior and posterior ocular anatomy, to include normal and abnormal vascular patterns. Used in this fashion, for example, ophthalmic imaging data can be used for diagnosis and management of diabetic retinopathy or glaucoma. Dermatologic information can include, for example, information derived from photographic information, varying in both color resolution and electromagnetic spectrum, and used to detect features related to surface texture and structure, including, for example, analysis of suspicious cutaneous nevi.

4. Database Formulation

The method of formulating data points, derived data, and data attributes database according to the present invention may comprise the following: (1) the collection of data points, said data points comprising information obtained from an x-ray image, for example, bone mineral density or structure information or obtained from an ultrasound measurement, or obtained from a CT scan, or obtained from a nuclear scintigraphic study, or obtained from a SPECT scan, or obtained from a PET scan, or obtained from an MRI scan, or obtained from an MRI spectroscopy study, or obtained from a histologic image or section, or obtained from a cytologic image or section, or obtained from another medical image including a photograph or obtained from another medical test; and (2) the association of those data points with relevant data point attributes. The method may further comprise (3) determining derived data points from one or more direct data points and (4) associating those data points with relevant data point attributes. The method may also comprise (5) collection of data points using a remote system server whereby the remote system server operates in a networked environment, along any of the lines described above.

In one embodiment, the information may be obtained from an x-ray image, for example of an anatomical structure or of a non-living structure. X-ray images can be acquired at a local site, such as an information collection terminal 102, using known techniques. If the x-ray image was captured using conventional x-ray film, the data points (information) of the x-ray image can be digitized using a scanning device. The digitized x-ray image information can then be transmitted over the network, e.g. the Internet, into a remote system server. If the x-ray image was acquired using digital acquisition techniques, e.g. using phosphorus plate systems or selenium or silicon detector systems, the x-ray image information is already available in digital format. In such a case the image can be transmitted directly over the network, e.g. the Internet. The information can also be compressed and/or encrypted prior to transmission. Information can also be transferred by other methods such as fax, mail, data storage medium, or the like.

One skilled in the art can readily recognize that the information can also be obtained from other tests such as an ultrasound measurement, a CT scan, a nuclear scintigraphic study, a SPECT scan, a PET scan, an MRI scan, an MRI spectroscopy study, or a histologic image or section, or a cytologic image or section, or another medical image including a photograph or another medical test.

a. Data Points

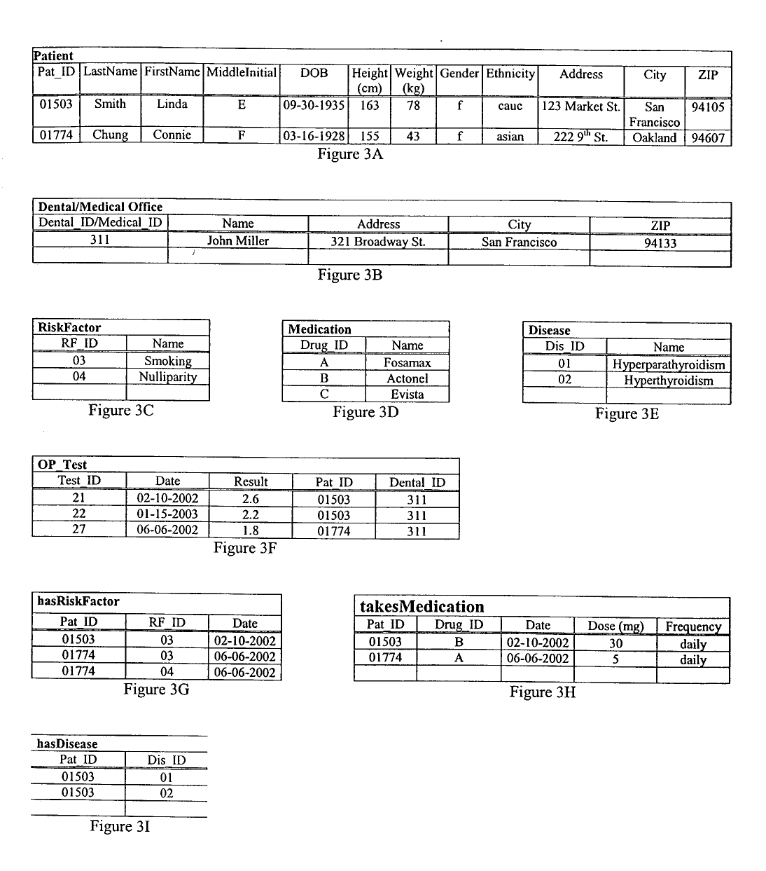

Thus, the methods of formulating data points, derived data, and data attributes database that forms an aspect of the present invention begins with the collection of data sets of measurement values, for example measurements of bone mass, bone mineral density, or bone structure, extracted from x-ray or other radiographic images, or measurements of tissue echogenicity or volume or flow or others extracted from an ultrasound scan, or measurement of tissue composition or density or volume or other information extracted from a CT scan, or measurement of radioactivity or radionuclide uptake extracted from a radionuclide scan, SPECT scan or PET scan, or measurement of tissue volume, signal, thickness, relaxation time or other parameters extracted from an MRI scan, or measurement of cell density, mitotic activity, nuclear polymorphism or other parameters extracted from a histologic image or section, or measurement of mitotic activity, nuclear polymorphism or other parameters extracted from a cytologic image or preparation, or measurement of other parameters extracted from other medical images including photographs of normal and diseased tissues or measurement of other parameters extracted from other medical tests. As shown in FIG. 3F, the measurement values for subject 01503 is shown as 2.6 on Feb. 10, 2002, and is 2.2 on Jan. 15, 2003. The measurement value for subject 01774 is 1.8 on Jun. 6, 2002.

The database formulation method of the present invention may further comprise the calculation of derived or calculated data points from one or more acquired data points. A variety of derived data points may be useful in providing information about individuals or groups during subsequent database manipulation, and are therefore typically included during database formulation. Solely by way of example, in the case of x-ray imaging, derived data points can include, but are not limited to the following: (1) maximum bone mineral density, determined for a selected region of bone or in multiple samples from the same or different subjects; (2) minimum bone mineral density, determined for a selected region of bone or in multiple samples from the same or different subjects; (3) mean bone mineral density, determined for a selected region of bone or in multiple samples from the same or different subjects; (4) the number of measurements that are abnormally high or low, determined by comparing a given measurement data point with a selected value; and the like. Other measurements relative to this kind of imaging can include data such as bone structure. Bone structure measurements, can, for example, include trabecular area, marrow area, trabecular perimeter, trabecular distance transform, marrow distance transform, trabecular bone pattern factor, and measurements derived thereof. Furthermore, measurements from a skeletonized image of trabecular bone can, for example, include node count, segment count, node-to-node segment count, node-to-node segment length, orientation angle of each segment, trabecular thickness, and measurements derived from these values. Other derived data points will be apparent to persons of ordinary skill in the art in light of the teachings of the present specification. The available data and data derived from (or arrived at thorough analysis of) the original data provide an unprecedented amount of information. In the case of x-ray imaging of ones, this information is very relevant to management of bone related diseases such as osteoporosis. For example, by examining subjects over time, the efficacy of medications an be assessed. In the case of x-ray imaging of dental structures such as teeth, dentin, enamel, mandible and maxilla, this information is relevant to management of dental related diseases such as periodontal disease.

Measurements and derived data points are collected and calculated, respectively, and may be associated with one or more data attributes to form a database.

Data attributes can be automatically input with the images or medical tests exemplified or enumerated above, for example with an x-ray image, ultrasound, CT scan, radionuclide scan, SPECT scan, PET scan, MRI image, etc., and can include but need not be limited to chronological information, e.g., date information shown in FIG. 3F, the type of imager, e.g. an x-ray imager or MRI machine, or medical equipment used, scanning information, digitizing information and the like. Alternatively, data attributes can be input by the subject and/or operator, for example subject identifiers. These identifiers include but are not limited to the following: (1) a subject code, e.g., a numeric or alpha-numeric sequence shown as Pat-ID in FIG. 3A; (2) subjects' demographic information such as date of birth, race, gender and address shown in FIG. 3A; (3) subjects' physical characteristics information such as weight and height shown in FIG. 3A, and body mass index (BMI); (4) subjects' risk factors, e.g., disease states or conditions, as shown in FIG. 3G; (5) disease-associated characteristics such as the type of disorder, e.g. a bone or dental disorder, if any, as shown in FIG. 31; (6) the type of medication used by the subject, as shown in FIG. 3H; and (7) information about the information collection terminal, as shown in FIG. 3B. In the practice of the present invention, each data point would typically be identified with the particular subject, as well as the demographic, characteristics and other related information of that subject.

Other data attributes will be apparent to persons of ordinary skill in the art in light of the teachings of the present specification.

b. Storage of Data Sets and Association of Data Points with Relevant Data Attributes

There are a number of formats for storing data sets and simultaneously associating related attributes, including but not limited to (1) tabular, (2) relational, and (3) dimensional. In general the databases can comprise data points, a numeric value which corresponds to physical measurement (an “acquired” datum or data point) or to a single numeric result calculated or derived from one or more acquired data points that are obtained using the various methods disclosed herein. The databases can include raw data or can also include additional related information, for example data tags also referred to as “attributes” of a data point. The databases can take a number of different forms or be structured in a variety of ways.

The most familiar format is tabular, commonly referred to as a spreadsheet. A variety of spreadsheet programs are currently in existence, and are typically employed in the practice of the present invention, including but not limited to Microsoft Excel® spreadsheet software and Corel Quattro® spreadsheet software. In this format, association of data points with related attributes occurs by entering a data point and attributes related to that data point in a unique row at the time the measurement occurs.

FIGS. 3A to 3I are schematic representations of database table structures for the central database 100 of the present invention in a spreadsheet-like format. FIG. 3A illustrates a table that contains subjects' demographic information, e.g., name, date of birth, gender, ethnicity and address, and physical characteristics information, e.g., height and weight. In one embodiment, each subject may be assigned a unique identifier. FIG. 3B illustrates a table that contains identity information of information collection terminals 102. Each terminal may be assigned a unique identifier. FIG. 3E illustrates a table listing identity information of the diseases for which the system collects information, e.g., osteoporosis. FIG. 3C illustrates a table listing identity information of the risk factors for those diseases. FIG. 3D illustrates a table listing identity information of medications used to treat those diseases. FIG. 3F illustrates a test result table that contains measurement values, test date, subject identification information (Pat_ID), and terminal identification information (Dental_ID). FIG. 3G illustrates a table that contains the risk factors that each subject has. FIG. 3H illustrates a table that contains the treatment information, including the name of the drugs each subject is taking, dosage, and frequency. FIG. 31 illustrates a table that contains the disease each subject has.

Further, rational, relational (Database Design for Mere Mortals, by Michael J. Hernandez, 1997, Addison-Wesley Pub. Co., publisher; Database Design for Smarties, by Robert J. Muller, 1999, Morgan Kaufmann Publishers, publisher; Relational Database Design Clearly Explained, by Jan L. Harrington, 1998, Morgan Kaufmann Publishers, publisher) and dimensional (Data-Parallel Computing, by V. B. Muchnick, et al., 1996, International Thomson Publishing, publisher; Understanding Fourth Dimensions, by David Graves, 1993, Computerized Pricing Systems, publisher) database systems and management may be employed as well.

Relational databases typically support a set of operations defined by relational algebra. Such databases typically include tables composed of columns and rows for the data included in the database. Each table of the database has a primary key, which can be any column or set of columns, the values for which uniquely identify the rows in a table. The tables in the database can also include a foreign key that is a column or set of columns, the values of which match the primary key values of another table. Typically, relational databases also support a set of operations (e.g., select, join and combine) that form the basis of the relational algebra governing relations within the database.

Such relational databases can be implemented in various ways. For instance, in Sybase® (Sybase Systems, Emeryville, Calif.) databases, the tables can be physically segregated into different databases. With Oracle® (Oracle Inc., Redwood Shores, Calif.) databases, in contrast, the various tables are not physically separated, because there is one instance of work space with different ownership specified for different tables. In some configurations, databases are all located in a single database (e.g., a data warehouse) on a single computer. In other instances, various databases are split between different computers.

Below is an example for an object-oriented database schema in Object Definition Language (ODL) notation:

interface Patient {

attribute string lastName;
attribute string firstName;
attribute char middleInitial;
attribute string dob;
attribute float height;
attribute float weight;
attribute char gender;
attribute string ethnicity;
attribute string address;
attribute string city;
attribute string zip;
relationship Set<OP_Test> test

inverse OP_Test::patient;

relationship Set<RiskFactor> riskFactor;
relationship Set<Medication> medication

inverse Medication::patient;

relationship Set<Disease> disease;

}
interface DentalOffice {

attribute string name;
attribute string address;
attribute string city;
attribute string zip;
relationship Set<OP_Test> test

inverse OP_Test::dentalOffice;
}
interface RiskFactor {

attribute string name;

}
interface Medication {

attribute string name;
relationship Set<Patient> patient

inverse Patient::medication;

}
interface Disease {

attribute string name;

}
interface OP_Test {

attribute string date;
attribute integer result;
relationship Patient patient

inverse Patient::test;

relationship DentalOffice dentalOffice

inverse DentalOffice::test;

}

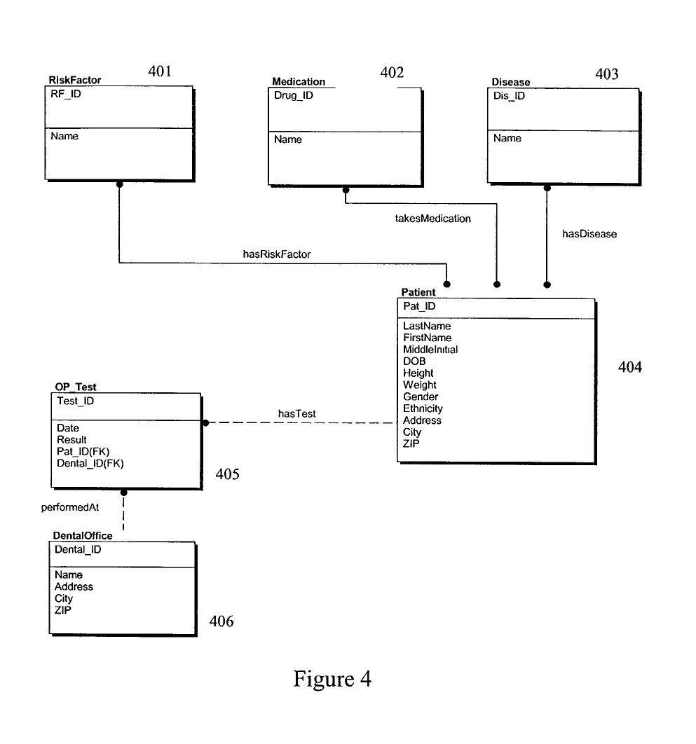

FIG. 4 illustrates the inter-relationship among tables and files of the central database 100. The test result table 405 obtains subjects' demographic information and physical characteristics information from table 404, which in turn obtains the subjects' risk factor information, treatment information and disease information from tables 401, 402, and 403, respectively.

It should be understood, of course, that the central database could store other related information, e.g., census information (such as information of the 2000 US census or other similar information that governmental bodies may gather on a periodic or an aperiodic basis), dietary preferences of people of different regions, and variations in mineral content of drinking water of different regions. In addition, the databases are not limited to the foregoing arrangements or structures. A variety of other arrangements will be apparent to those of skill in the art.

5. Database Manipulation

Databases formulated using the methods of the present invention are useful in that they can be manipulated, for example, using a variety of statistical analyses, to produce useful information. The databases of the present invention may be generated, for example, from data collected for an individual or from a selected group of individuals over a defined period of time (e.g., days, months or years), from derived data, and from data attributes.

The present invention further relates to a method for manipulating data points, derived data, and data attributes database in order to provide a useful result, the method comprising providing data points, derived data, and data attributes database, and manipulating and/or analyzing the database.

For example, data sets may be aggregated, sorted, selected, sifted, clustered and segregated by means of the attributes associated with the data points. A number of database management systems and data mining software programs exist which may be used to perform the desired manipulations.

Relationships in the database can be directly queried and/or the data analyzed by statistical methods to evaluate the information obtained from manipulating the database.

For example, a distribution curve can be established for a selected data set, and the mean, median and mode calculated therefor. Further, data spread characteristics, e.g. variability, quartiles and standard deviations can be calculated.

The nature of the relationship between a particular variable and bone mineral density levels can be examined by calculating correlation coefficients. Useful methods for doing so include but are not limited to the following: Pearson Product Moment Correlation and Spearman Rank Order Correlation.

Analysis of variance permits testing of differences among sample groups to determine whether a selected variable has a discernible effect on the parameter being measured.

Non-parametric tests may be used as a means of testing whether variations between empirical data and experimental expectancies are attributable merely to chance or to the variable or variables being examined. These include, but are not limited to the Chi Square test, the Chi Square Goodness of Fit, the 2×2 Contingency Table, the Sign Test, and the Phi Correlation Coefficient.

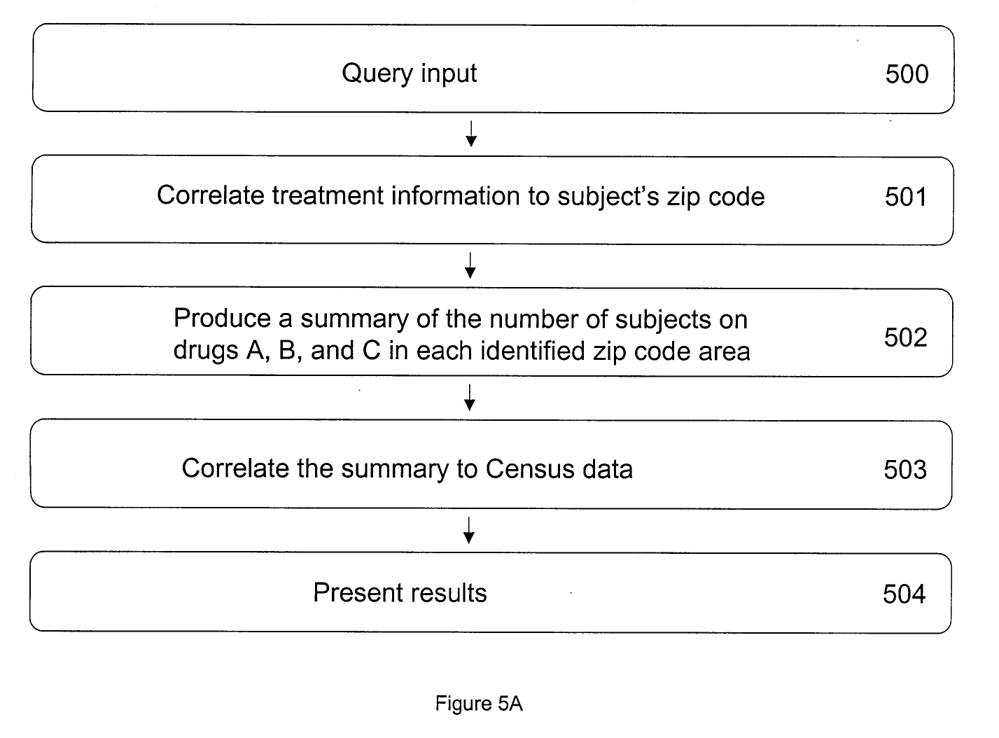

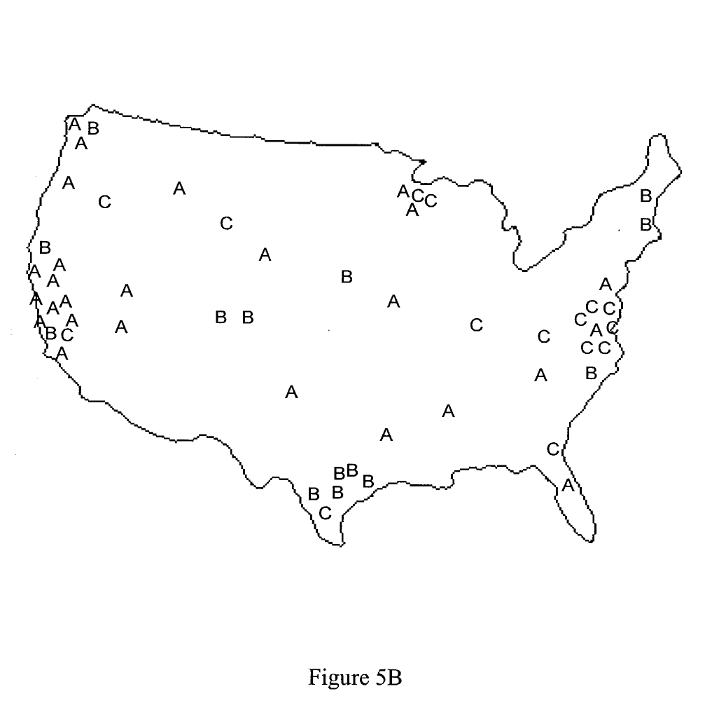

FIG. 5A is a flow diagram illustrating an embodiment of the method of the present invention for manipulating central database 100 to produce market penetration data of different drugs in a particular region, and FIG. 5B is an example of the result obtained by the method. As shown in FIG. 3D, the central database of the present invention can store subjects' treatment information, including Drug-ID, the name of drugs that a subject may be taking, and the dosage per unit of time that subjects reportedly are taking at the time that a medical test of the type exemplified above, including but not limited to dental or other x-ray images, or an ultrasound, or a CT scan, or a radionuclide scan, or a SPECT scan, or a PET scan, or an MRI scan, or a laboratory test, or confocal microscopy, or cytology or histology or a photograph of normal or diseased tissue is performed. Looking at FIG. 5A, at step 500, an authorized user inputs a query, such as “market penetration data of drugs A, B, and C in the US.” At step 501, the treatment information corresponding to the query is correlated to subjects' zip codes to get a summary of drug data characterized by zip code. Other geographic delimiters, such as state, county, city, township, or area code also may be used. At step 502, a summary of the number of subjects on drugs A, B and C in each identified zip code area is produced Merely by way of example, FIG. 3D includes three drugs for treating osteoporosis. Drugs for treating other bone-related diseases or disorders, or for treating other diseases or disorders for which information may be derived from any of the various images and tests exemplified or enumerated earlier, also are within the contemplation of the invention. At step 503, the numbers of subjects taking drug A, B or C, per 1000 population in each identified zip code (or other geographically delimited) area is produced through cross correlation of the above summary to demographic data (such as census data) At step 504, the result is presented to the user. FIG. 5B provides a representative example of this step, where each ZIP code area, in which the number of subjects taking drug A, B, or C per 1000 population exceeds a certain fixed threshold, is represented by a letter for the respective drug on the geographical map. Alternatively, ranges of numbers of subjects taking particular drug could be represented by letters or symbols of varying sizes. For example, 0-50 subjects in a ZIP code area taking drug A could be represented by the symbol •, 50-100 subjects taking drug A by the symbol ▪, and more than 100 subjects taking drug A by the symbols •.

Furthermore, by taking into account subject demographic information, the number of subjects taking a particular drug per demographically matched 1000 population within the geographically defined area is available. Similarly, physical characteristics and risk factors can be used to get the numbers of subjects taking a particular drug in sub-groups. It should be noted that, while demographic data per 1000 population is used here as an example, the invention should not be considered as limited by this statistical approach. In some circumstances, it may be easier, more effective, and/or more appropriate to provide other types of data. For example, absolute numbers of patients taking a particular drug may be used, where absolute numbers provide an appropriate indication, unencumbered by statistical occurrence of either a particular disease or disorder, or particular drug administration in a larger population.

Alternatively, at step 501, the treatment information can be correlated to the zip codes (or other relevant geographic information) of the information collection terminals 102, instead of corresponding information for the subjects, to get a summary of drug data characterized by terminal location.

It should be understood that market penetration data can be obtained by manipulating the database of the present invention in other ways, for example, by correlating the summary of the number of subjects taking drugs A, B, or C produced at step 502, to the total number of subjects who have a given disease, e.g., osteoporosis, in that region, or by correlating the total amount of a particular drug, e.g., drug A, taken by subjects, to the total amount of all drugs of interest, i.e., A, B, and C, taken by all subjects of that disease in that region.

The resulting market penetration data of different drugs in a particular region can be presented to users in various different ways. One such manner of presentation is illustrated in FIG. 5B. From the depiction in FIG. 5B, it can be seen that relatively large quantities of drug A are sold in California; that drug B has a relatively dominant position in states such as Missouri and Louisiana, while drug C appears to be prescribed predominantly in the Midwest and the east coast states. Through mining the central database of the present invention using known data mining techniques, authorized users of the central database, e.g., pharmaceutical companies, can determine areas where their drugs have relatively lower penetration, and where their drugs are underrepresented based on a particular demographic variable, and can adjust their marketing strategy accordingly.

Moreover, all information entered into the central database 100 can be time stamped. Consequently, changes of market shares of different drugs over time in a particular area will be available to the authorized users. Such dynamic marketing data can be normalized by demographic information, physical characteristics, and risk factors.

FIGS. 5A and 5B relate to osteoporosis merely by way of example. As has been stated variously throughout this specification, it will be apparent to those of working skill in the art that similar applicability to a number of different diseases along the lines described previously will be within the contemplation of the invention.

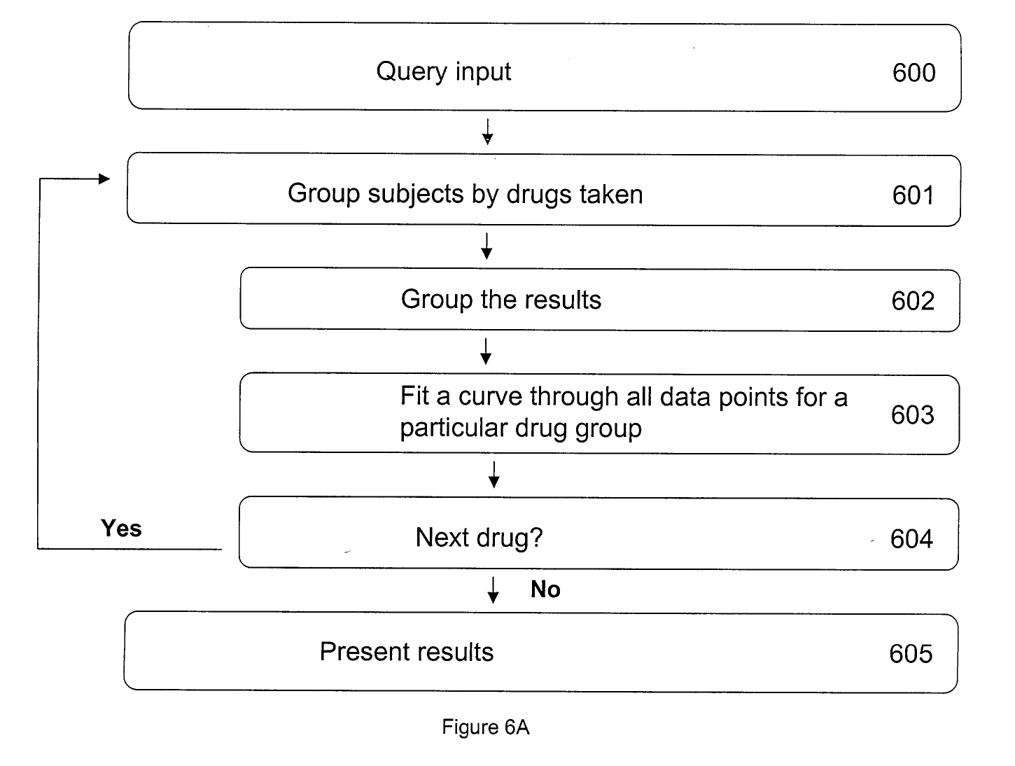

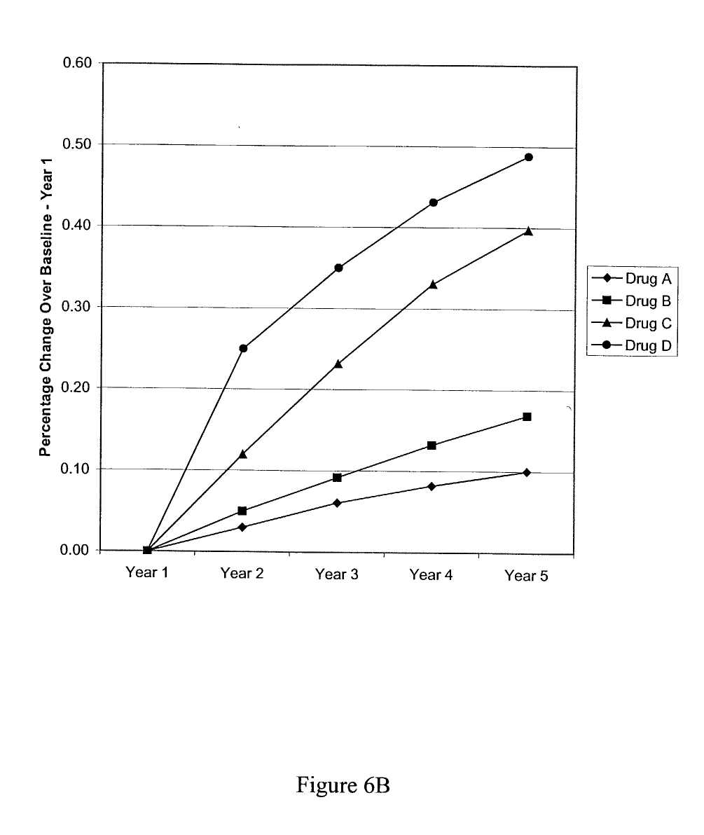

FIG. 6A is a flow diagram illustrating a method of manipulating the central database 100 of the present invention to compare efficacy of different drugs, and FIG. 6B is an example of the result obtained by the method. As shown in FIG. 3F, the central database 100 stores the subjects' medical historical information, including measurement values, e.g., bone mass values, bone density values, or bone structure values for osteoporosis, stamped by time of test. The measurement values include the value, e.g. bone mass or bone structure, for the baseline test right before beginning the drug treatment, and that for every follow-up measurement. Looking at FIG. 6A, at step 600, an authorized user inputs a query, for example, “efficacy of drugs A, B, and C.” At step 601, subjects are grouped by the drugs taken. At step 602, for a group of subjects taking a particular) drug, measurement values for all follow-up tests over the time are given, and thus results are provided in groups of form, time since baseline test, and percent change with respect to baseline test. At step 603, a curve will be fitted through all the data points for a particular drug group. At step 604, if the process is desired for another drug, the process will repeat, so that a curve will be produced for each of the desired drug groups. At step 605, the results are presented to the user. As shown in FIG. 6B, for each time point, points on the curves of the different drug groups can then be compared.

In addition, each drug group can be further divided into sub-groups by subject demographic information, physical characteristics, risk factors, etc., so as to take into account or to identify differences in the response to a certain drug treatment due to gender, age, race, weight and/or nutrition. The resulting curves will allow the authorized users to compare the efficacy of different drugs in each of the sub-groups.

It should be understood that the efficacy of different drugs can be presented to authorized users in other ways, for example, quantitative data in table format, histogram or bar chart.

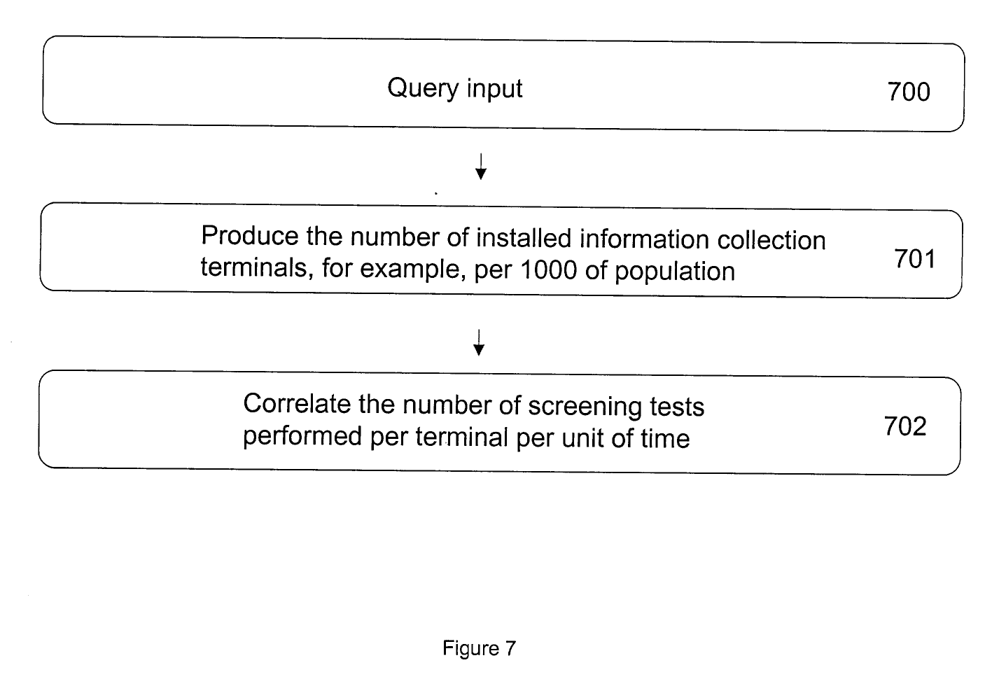

FIG. 7 is a flow diagram illustrating an embodiment for manipulating the central database to produce screening rates for diseases, e.g., osteoporosis. As shown in FIG. 3B, the central database 100 stores identity information of information collection terminals, e.g., dental offices. As illustrated, the identity information includes Dental-ID or Medical-ID, and zip code of that dental or medical office. Again, it should be noted that the precise source of the information is not critical—there may be offices, for example, that one might not think of as a “dental office” or a “medical office” per se, but which perform testing services, such as MRI, ultrasound, etc. These offices, as sources of data, are within the comprehended scope of the invention. Looking at FIG. 7, at step 701, the number of installed information collection terminals, for example per 1000 of the population is produced, using, for example, demographic data such as census data for normalization. The census data will vary according to country. Also, regional, rather than national sources of demographic information may be readily obtainable, and equally suitable to the purpose. At step 702, the number of installed information collection terminals, for example per 1000 of population, is correlated to the number of screening tests performed per terminal per unit time, and the screening rate, i.e., the number of screenings per installed terminals, for example per 1000 of population, per unit time is derived. Based on the demographics of the geographic region, the screening rate for bone-related diseases such as osteoporosis in different geographic areas, or of different demographics sub-groups, will be available. The screening rate could be used by the authorized users of the system to evaluate the availability of osteoporosis screen in different regions, and to normalize data during manipulation of the central database, such as those described in FIGS. 5 and 6.

The central database could also be used by authorized users to analyze prevalence of diseases. For example, government or research institutes can perform regional comparisons to detect relations between the prevalence of diseases and climate, geographic conditions, dietary preferences or mineral content of drinking water of particular regions.

There are numerous tools and analyses available in standard data mining software that can be applied to the analysis of the databases of the present invention. Such tools and analyses include, but are not limited to, cluster analysis, factor analysis, decision trees, neural networks, rule induction, data driven modeling, and data visualization. Some of the more complex methods of data mining techniques are used to discover relationships that are more empirical and data-driven, as opposed to theory-driven, relationships.

Exemplary data mining software that can be used in analysis and/or generation of the databases of the present invention includes, but is not limited to: Link Analysis (e.g., Associations analysis, Sequential Patterns, Sequential time patterns and Bayes Networks); Classification (e.g., Neural Networks Classification, Bayesian Classification, k-nearest neighbors classification, linear discriminant analysis, Memory based Reasoning, and Classification by Associations); Clustering (e.g., k-Means Clustering, demographic clustering, relational analysis, and Neural Networks Clustering); Statistical methods (e.g., Means, Std dev, Frequencies, Linear Regression, non-linear regression, t-tests, F-test, Chi2 tests, Principal Component Analysis, and Factor Analysis); Prediction (e.g., Neural Networks Prediction Models, Radial Based Functions predictions, Fuzzy logic predictions, Times Series Analysis, and Memory based Reasoning); Operating Systems; and Others (e.g., Parallel Scalability, Simple Query Language functions, and C++objects generated for applications). Companies that provide such software include, for example, the following: Adaptative Methods Group at UTS (UTS City Campus, Sydney, NSW 2000), CSI®, Inc., (Computer Science Innovations, Inc. Melbourne, Fla.), IBM® (International Business Machines Corporation, Armonk, N.Y.), Oracle® (Oracle Inc., Redwood Shores, Calif.) and SAS® (SAS Institute Inc., Cary, N.C.).

These methods and processes may be applied to the databases of the present invention, for example, databases comprising, x-ray image data sets, ultrasound data sets, CT data sets, MRI data sets, radionuclide imaging data sets, SPECT data sets, PET data sets, data sets derived from analysis of medical photographic techniques, laser enhanced imaging, and various biomicroscopy techniques, derived data, and data attributes.

For a general discussion of statistical methods applied to data analysis, see Applied Statistics for Science and Industry, by A. Romano, 1977, Allyn and Bacon, publisher.

6. Graphical User Interface

In certain computer systems, an interface such as an interface screen that includes a suite of functions is included to enable users to easily access the information they seek from the methods and databases of the invention. Such interfaces usually include a main menu page from which a user can initiate a variety of different types of analyses. For example, the main menu page for the databases generally include buttons for accessing certain types of information, including, but not limited to, project information, inter-project comparisons, times of day, events, dates, times, ranges of values, etc.

When an authorized user accesses the central database to obtain, for example, marketing information of different drugs, the graphical user interface allows the user to enter the name of the drug and the geographic region of interest. The interface could be a menu driven choice, or a visual map allowing users to select geographies visually, e.g., by zip codes, area codes, townships, counties, states or countries. The interface could also allow the user to input the query in natural or abbreviated language. The resulting data, market penetration of different drugs, could be displayed, for example, qualitatively on a map, or quantitatively in tables or graphs.

When an authorized user wants to compare efficacy of different drugs, the graphical user interface allows the user to enter the name of the drug of interest. The interface could be a menu driven choice allowing the user to select the factor on which the manipulation of data is based, e.g., period of time, race, age, gender, weight etc. Alternatively, the user interface could be a window that allows the user to input the query in either natural or abbreviated language. At mentioned above, the resulting efficacy of different data could be presented by curves, quantitative data in table format, histogram or bar chart.

7. Computer Program Products

A variety of computer program products can be utilized for conducting the various methods and analyses disclosed herein. In general, the computer program products comprise a computer-readable medium and the code necessary to perform the methods set forth supra. The computer-readable medium on which the program instructions are encoded can be any of a variety of known medium types, including, but not limited to, solid-state memory, hard drives, removable storage such as (but not limited to) ZIP® drives, WORM drives, magnetic tape and optical media such as CD-ROMs or DVD ROMs or DVD RAMS.

For example, once an x-ray, an ultrasound, a CT, an MRI, a radionuclide scan, a SPECT scan, a PET scan or data derived from analysis of medical photographic techniques, laser enhanced imaging, and various biomicroscopy techniques are transmitted via a local or long-distance computer network and the data received by a remote computer or a computer connected to the remote network computer, an analysis of the morphology of the object can be performed, for example using suitable computer programs. Alternatively, said analysis can be performed on an information collection terminal. The resultant data can then be transferred into a remote computer or a computer connected to the remote network computer. This analysis of the object's morphology can occur in two-dimensions, although it is also possible in three-dimensions. Three-dimensional analyses can be performed, for example, when x-ray images have been acquired through the anatomic object using multiple different x-ray transmission angles. For example, in imaging osseous structures, such morphological analysis of a transmitted x-ray image can be used to measure parameters that are indicative or suggestive of bone loss or metabolic bone disease. Such parameters include all current and future parameters that can be used to evaluate osseous structures. For example, such parameters include, but are not limited to, trabecular spacing, trabecular thickness, and intertrabecular space.

X-ray, ultrasound, CT, MRI, radionuclide, SPECT scan, PET scan or data derived from analysis of medical photographic techniques, laser enhanced imaging, and various biomicroscopy techniques can be compressed prior to the transmission via a local or long-distance computer network. An analysis of the data can be performed prior to transmission of the data via a local or long-distance computer network. Transmitted data can be limited to the results of said analyses. Alternatively, a partial analysis can be performed prior to transmission of the data with the analysis being completed by a remote computer or a computer connected to the remote network computer.

Information on the morphology or 2D or 3D morphology of an anatomic structure can be derived more accurately, when acquisition parameters such as spatial resolution are known for an x-ray, ultrasound, CT, MRI, radionuclide, SPECT scan, PET scan or data derived from analysis of medical photographic techniques, laser enhanced imaging, and various biomicroscopy techniques. In one embodiment of the invention, such test parameters can be transmitted along with the test data. Such transmission of these test parameters can also occur prior to or after transmission of the test data.

As noted above, an x-ray, ultrasound, CT, MRI, radionuclide, SPECT scan, PET scan or data derived from analysis of medical photographic techniques, laser enhanced imaging, and various biomicroscopy techniques can be transmitted from a local site into a remote system server and the remote system server can perform an automated analysis of the data. Further, the remote system server or a computer connected to the remote system server can then generate a diagnostic report. Thus, in certain embodiments, a computer program (e.g., on the remote system server or on a computer connected to the remote system server) can generate charges for the diagnostic report. The remote server can then transmit the diagnostic report to a physician or a dentist, typically the physician or dentist who ordered the test or who manages the patient. The diagnostic report can also be transmitted to third parties, e.g. health insurance companies. Such transmission of the diagnostic report can occur electronically (e.g. via e-mail), via mail, fax or other means of communication. All or some of the transmitted information (e.g., subject identifying information) can be encrypted to preserve confidentiality of medical records.

A remote computer or a computer connected to the remote network computer can perform quality checks and quality assurance of the data from the x-ray, ultrasound, CT, MRI, radionuclide, SPECT scan, PET scan or data derived from analysis of medical photographic techniques, laser enhanced imaging, and various biomicroscopy techniques. These quality checks or quality assurance can include assessments of image quality, image resolution, image contrast and others. These quality checks or quality assurance can be fully automated. Alternatively, there can be partial and, in selected cases, full human interaction. The remote computer or a computer connected to the remote network computer can perform these quality checks and quality assurance of the data in all samples or subsets of samples. Such samples can be random samples.

Typically, one or more computer programs capable of generating bills will also be employed, for example a bill-making program on the remote server. The charges on the bill will typically follow general medical reimbursement guidelines. The bill can be transmitted electronically (e.g. via e-mail), via mail, fax or other means of communication. Splitting of fees can also be performed by these programs, for example where a percentage of the fee for the diagnostic test is transferred to the physician responsible for interpreting the test, a percentage of the fee for the diagnostic test is transferred to the agency, e.g. a hospital, x-ray clinic, women's clinic, dentist's office acquiring the x-ray image, and a percentage of the fee for the diagnostic test is transferred to the entity responsible for the extraction of x-ray information and automated analysis. Such fees can contain a professional and a technical component. These fees can also be charged by a central facility. The central facility can then pay a dentist or a physician, for example as an independent contractor. The central facility can also pay a hospital or other healthcare organization. Bills can be transmitted simultaneously with the transmission of the results of the automated network based analysis or can be transmitted after the report is sent. Similarly, payment can be collected using any suitable medium, for example payment by credit card over the internet or by mail.

8. Calibration Phantoms and Reference Standards

Although a wealth of information can be obtained from x-ray or other radiographic images alone, in certain embodiments the networked x-ray, ultrasound, CT, MRI, radionuclide, SPECT scan, PET scan or data derived from analysis of medical photographic techniques, laser enhanced imaging, and various biomicroscopy techniques or data from other medical tests include one or more accurate reference markers, for example calibration phantoms or reference standards, for example for assessing bone mineral density of a given x-ray image. Thus, in certain aspects, the current invention provides for methods and devices that allow accurate quantitative assessment of information contained in an x-ray, ultrasound, CT, MRI, radionuclide, SPECT scan, PET scan or data derived from analysis of medical photographic techniques, laser enhanced imaging, and various biomicroscopy techniques such as density of an anatomic structure or morphology of an anatomic structure in a network environment.

If x-ray imaging is used, an x-ray image can be acquired using well-known techniques from any local site. For example, in certain aspects, 2D planar x-ray imaging techniques are used. 2D planar x-ray imaging is a method that generates an image by transmitting an x-ray beam through a body or structure or material and by measuring the x-ray attenuation on the other side of said body or said structure or said material. 2D planar x-ray imaging is distinguishable from cross-sectional imaging techniques such as computed tomography or magnetic resonance imaging. If the x-ray image was captured using conventional x-ray film, the x-ray can be digitized using any suitable scanning device or video system. The digitized x-ray image is then transmitted over the network, e.g. the Internet, into a remote computer or server. It will be readily apparent that x-ray images can also be acquired using digital acquisition techniques, e.g. using phosphorus plate systems or selenium or silicon detector systems, the x-ray image information is already available in digital format. In this case the image can be transmitted directly over the network, e.g. the Internet, or alternatively, it can be compressed prior to transmission.

In one embodiment, when an image of an anatomic structure or a non-living object is acquired, a calibration phantom is included in the field of view. Any suitable calibration phantom can be used, for example, one that comprises aluminum or other radio-opaque materials. U.S. Pat. No. 5,335,260 describes other calibration phantoms suitable for use in assessing bone mineral density in x-ray images. Examples of other suitable calibration reference materials can be fluid or fluid-like materials, for example, one or more chambers filled with varying concentrations of calcium chloride or the like.

Alternatively, the calibration phantom or reference standard can be imaged separately either before or after the image of the living or non-living subjects is obtained. The image of the calibration phantom or reference standard can then be either stored locally or can be transmitted over the network. If the image is stored locally on a computer storage medium, said image or said stored information can be used to calibrate the images prior to or during or after transmission over the network.

It will be readily apparent that a calibration phantom can contain several different areas of different radio-opacity. For example, the calibration phantom can have a step-like design, whereby changes in local thickness of the wedge result in differences in radio-opacity. Stepwedges using material of varying thickness are frequently used in radiology for quality control testing of x-ray beam properties. By varying the thickness of the steps, the intensity and spectral content of the x-ray beam in the projection image can be varied. Stepwedges are commonly made of aluminum, copper and other convenient and homogeneous materials of known x-ray attenuation properties. Stepwedge-like phantoms can also contain calcium phosphate powder or calcium phosphate powder in molten paraffin.

Alternatively, the calibration reference may be designed such that the change in radio-opacity is from periphery to center (for example in a round, ellipsoid, rectangular of other shaped structure). As noted above, the calibration reference can also be constructed as plurality of separate chambers, for example fluid filled chambers, each including a specific concentration of a reference fluid (e.g., calcium chloride).

Whatever the overall shape of the calibration phantom, in one embodiment, at least one marker can be present at a known density in the phantom. Presently, areas of the calibration phantom will often fail to appear on x-ray images. This is particularly true of areas at the highest and lowest density levels. Thus, it is often difficult to determine what the density is of any particular area of the calibration phantom. The present invention solves this problem by ensuring that at least one geometric shape is included in the calibration phantom at a position of known density. Any shape can be used including, but not limited to, squares, circles, ovals, rectangles, stars, crescents, multiple-sided objects (e.g., octagons), irregular shapes or the like, so long as their position is known to correlate with a particular density of the calibration phantom. In some embodiments, the calibration phantoms described herein are used in 2D planar x-ray imaging. Alternatively, if the calibration phantom includes a continuous density gradient, the slope of the gradient, i.e. the change in relative density between two or more points can be used to determine the location within a calibration phantom and, ultimately, to calibrate or normalize the image data against the phantom.

Since the density and attenuation of the calibration phantom are both known, the calibration phantom provides an external reference for measuring the density of the anatomic structure or non-living object to be measured. As will be apparent to one of ordinary skill in the art, the invention comprehends other applications for use of calibration phantoms in x-ray imaging in view of the teachings herein.

The calibration phantoms can be imaged before or after the x-ray image is taken. Alternatively, the calibration phantom can be imaged at the same time as the x-ray image. The calibration phantom can be physically connected to an x-ray film and/or film holder. Such physical connection can be achieved using any suitable mechanical or other attachment mechanism, including but not limited to adhesive, a chemical bond, use of screws or nails, welding, a Velcro™ strap or Velcro™ material and the like. Similarly, a calibration phantom can be physically connected to a detector system or a storage plate for digital x-ray imaging using one or more attachment mechanisms (e.g., a mechanical connection device, a Velcro™ strap or other Velcro™ material, a chemical bond, use of screws or nails, welding and an adhesive).

The attachment may be permanent or temporary and the calibration phantom can be integral (e.g., built-in) to the film, film holder and/or detector system or can be attached or positioned permanently or temporarily appropriately after the film and/or film holder is produced. Thus, the calibration phantom can be designed for single-use (e.g., disposable) or for multiple uses with different x-ray images. Thus, in certain embodiments, the calibration phantom is reusable and, additionally, can be sterilized or disinfected between uses. Integration of a calibration phantom can be achieved by including a material of known x-ray density between two of the physical layers of the x-ray film. Integration can also be achieved by including a material of known x-ray density within one of the physical layers of the x-ray film. Additionally, the calibration phantom can be integrated into the film cover. A calibration phantom or an external standard can also be integrated into a detector system or a storage plate for digital x-ray imaging. For example, integration can be achieved by including a material of known x-ray density between two of the physical layers of the detector system or the storage plate. Integration can also be achieved by including a material of know x-ray density within one of the physical layers of the detector system or the storage plate.

In certain embodiments, for example those embodiments in which the calibration phantom is temporarily attached to the x-ray assembly, cross-hairs, lines or other markers may be placed on the apparatus as indicators for positioning of the calibration phantom. These indicators can help to ensure that the calibration phantom is positioned such that it doesn't project on materials that will alter the apparent density in the resulting image.

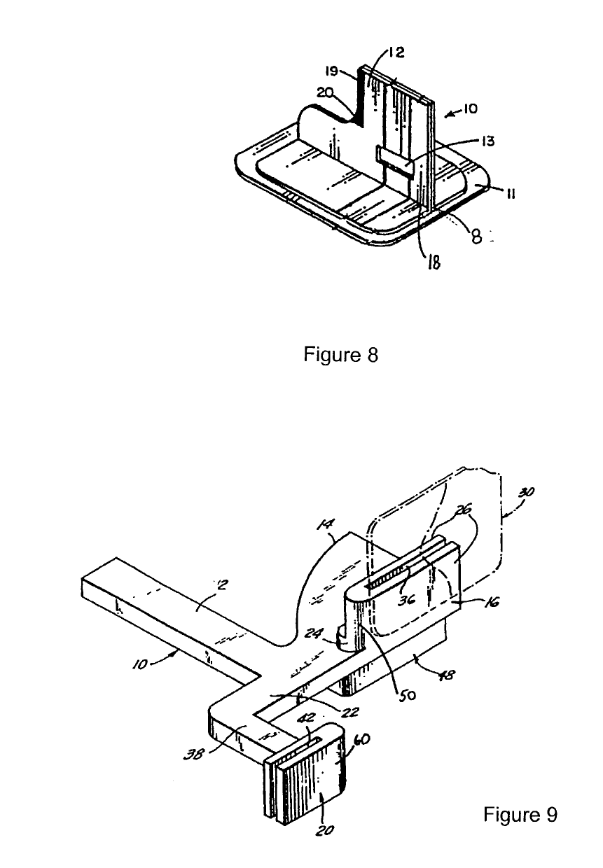

FIG. 8 and FIG. 9 show two examples of dental x-ray film holders that can be designed to include a calibration phantom. (See also U.S. Pat. Nos. 5,001,738 and 4,251,732). It should be noted that FIG. 8 and FIG. 9 depict only two shapes of any number of shapes suitable for x-ray film holders. Furthermore, although illustrated with respect to dental x-ray film and/or film holders, it will be readily apparent that calibration phantoms as described herein can be included in or with any type of x-ray film and/or film holder.

FIG. 8 shows a film packet (11) for holding x-ray film. Film packet (11) is within a bite wing film holder (10) that has a bite tab (12) extending perpendicular from the film holder (11). The opening (13) allows alignment on a patient's teeth. As shown, the bite tab (12) has a generally square shape. A curved cutaway portion (20) along one edge can be included to allow better aiming of the x-ray tube. A calibration phantom can be positioned in any suitable location on the holder or film following the teachings described herein. In some embodiments, it is desirable that the calibration phantom be positioned so it does not project on structures or materials that will alter the apparent density of the calibration phantoms. It is also desirable that the calibration phantom includes a marker (e.g, geometric pattern) at a known density to increase the accuracy of the phantom as an external standard. For example, in dental x-rays, the calibration phantom can be positioned where the bite wing (12) meets the film holder (11), for example near the bend (18) or along the area (8) created where the bite wing (12) meets the film holder (11). Such careful positioning ensures that the calibration phantom will appear in the x-ray image between the teeth and, therefore, will be more accurate than if bone (e.g., jaw) or teeth. It will be readily apparent that the area containing the calibration phantom can be made slightly thicker to ensure that the calibration phantom does not project on bone or dental tissue in the x-ray image.

Referring now to FIG. 9, another exemplary x-ray film holder (10) consists of one-piece construction with an extension (2) for alignment of the x-ray beam, and manual positioning of a bite platform (14) and film holding slotted portions (16), (48) and (20). The extension (2) is connected to platform (14) at a ‘T’ shaped area (22). Film holding slotted portion (16) is perpendicularly connected to platform (14) at (24) and comprises side walls (26) and slot (36) which are used to support film (30), for example in the upper right posterior exposure position as shown in FIG. 3. A calibration phantom (e.g., stepwedge, fluid chambers, etc.) can again be permanently or temporarily positioned in any suitable location, preferably so that it appears in the x-ray image but does not project on or with materials or structures that will alter the apparent density of the calibration references in the x-ray image. Non-limiting examples of such suitable positions include in film holder portions (16, 48, 20), for example within or on the surface of closed portion (50, 60) of the film holders. Other suitable locations can be readily determined following the teachings of the present specification.

The foregoing description of embodiments of the invention has been presented for the purposes of illustration and description. This description is not intended to be exhaustive or to limit the invention to the precise form or forms disclosed. Many modifications and variations are possible in light of the above teachings. It is intended that the scope of the invention be limited not by this detailed description, but rather by the claims appended hereto.

What is claimed is:

1. A system for building a quantitative information database, said system comprising:
a computer program for deriving quantitative information from subjects' medical images,
a computer receiving database information, said database information comprising said subjects' medical images, obtained during routine medical or dental care, or said quantitative information derived from said subjects' medical images, and subjects' personal information, said personal information being selected from the group consisting of demographic information, geographic information, information on risk factors associated with one or more diseases, disease-related factors, and disease-preventive factors, and
a central database collecting data from at least two sources, storing the quantitative information, and associating the quantitative information with the subjects' personal information.

2. The system according to claim 1, wherein said computer further receives subjects' treatment information comprising information regarding treatment that subjects are receiving for said one or more diseases.

3. The system according to claim 1, wherein said central database is installed on said computer.

4. The system according to claim 1, wherein said computer comprises a central system server.

5. The system according to claim 1, wherein said computer comprises a plurality of connected computers.

6. The system according to claim 2, wherein said central database and said treatment information provide data on efficacy of one or more treatments or drugs being administered to said subjects.

7. The system according to claim 2, wherein said central database and said treatment information provide data on market penetration of one or more drugs being administered to said subjects.

8. The system according to claim 1, wherein said computer receives said database information via a medium selected from the group consisting of a network, e-mail, a data storage medium, a scanner with text recognition software, and manual input.

9. The system according to claim 8, wherein when the medium is a network, the network is selected from the group consisting of the Internet, a local area network, and a network that is accessed via a remote connection.

10. The system according to claim 1, further comprising a plurality of information collection terminals, selected from the group consisting of a personal computer, a notebook computer, an embedded computer, a handheld computer, a personal digital assistant, and a pocket PC, for providing said database information.

11. The system according to claim 1, further comprising user access to said central database via a medium selected from the group consisting of the Internet, a local area network, a network accessed via a remote connection, e-mail, and a data storage medium.

12. The system according to claim 1, wherein the medical images are selected from the group consisting of medical x-rays, dental x-rays, computed radiographic images, digital radiographic images, ultrasound images, single x-ray absorptiometry scans, dual x-ray absorptiometry scans, CT scans, MRI scans, PET scans, and SPECT scans.

13. The system according to claim 1, wherein the computer further comprises a medical imaging apparatus for providing said medical images.

14. The system according to claim 13, wherein the medical imaging apparatus comprises a system selected from the group consisting of an x-ray apparatus, a computed radiography apparatus, a digital radiography apparatus, an ultrasound apparatus, a single x-ray absorptiometry apparatus, a dual x-ray absorptiometry apparatus, a CT scanner, an MRI apparatus, a PET scan apparatus, and a SPECT scan apparatus.

15. The system according to claim 14, wherein when the medical imaging apparatus is an x-ray apparatus, said x-ray apparatus is a dental x-ray apparatus.

16. The system according to claim 14, wherein when the medical imaging apparatus is an x-ray apparatus, said x-ray apparatus acquires images of skeletal areas selected from the group consisting of the hip joint, one or more vertebral bodies, forearm, upper arm, hand, wrist, lower leg, thigh, foot, ankle, knee joint, elbow joint, shoulder joint, ribs, cranium, mandible, or maxilla.

17. The system according to claim 1, wherein the quantitative information is selected from the group consisting of bone mass, bone mineral density, and bone structure information.

18. The system according to claim 2, wherein the central database further stores derived data points, calculated from the quantitative information and associated with the subjects' personal and treatment information.

19. The system according to claim 18, wherein the derived data points are selected from the group consisting of subjects' bone mass changes over time, subjects' bone density changes over time, and subjects' bone structure changes over time.

20. The system according to claim 19, wherein the derived data points indicate changes in dermatologic condition of said subjects over time.

21. The system according to claim 19, wherein the derived data points indicate changes in ophthalmic condition of said subjects over time.

22. The system according to claim 2, wherein subjects' medical images, and personal and treatment information are transferred in digital form to said computer.

23. The system according to claim 1, wherein when said subjects' personal information comprises demographic information, the demographic information comprises information selected from the group consisting of age, gender, race, address, area code, zip or postal code, city, county, state or province, and country.

24. The system according to claim 1, wherein said subjects' personal information comprises physical characteristic information.

25. The system according to claim 24, wherein the physical characteristic information comprises information selected from the group consisting of height and weight.

26. The system according to claim 1, wherein when said subjects' personal information comprises information on risk factors, the one or more diseases are bone-related diseases.

27. The system according to claim 26, wherein the bone-related disease is selected from the group consisting of osteoporosis, osteoarthritis, rheumatoid arthritis, and metabolic bone disease.

28. The system according to claim 2, wherein subjects' treatment information comprises drug and dosage information.

29. A method of building a quantitative information database, said method comprising:
receiving database information from at least two sources, said database information comprising subjects' medical images, obtained during routine medical or dental care, or quantitative information derived from said subjects' medical images, and subjects' personal information, said personal information being selected from the group consisting of demographic information, geographic information, information on risk factors associated with one or more diseases, disease-related factors, and disease-preventive factors,
wherein said receiving comprises either receiving said subjects' medical images and deriving quantitative information from said subjects' medical images, or receiving said quantitative information derived from said subjects' medical images,
storing the quantitative information; and
associating the quantitative information with the subjects' personal information in said database.

30. The method according to claim 29, further comprising receiving subjects' treatment information comprising information regarding treatment that subjects are receiving for said one or more diseases.

31. The method according to claim 30, further comprising providing data on efficacy of one or more treatments or drugs being administered to said subjects.

32. The method according to claim 30, further comprising providing data on market penetration of one or more drugs being administered to said subjects.

33. The method according to claim 29, wherein the medical images are selected from the group consisting of medical x-rays, dental x-rays, computed radiographic images, digital radiographic images, ultrasound images, single x-ray absorptiometry scans, dual x-ray absorptiometry scans, CT scans, MRI scans, PET scans, and SPECT scans.

34. The method according to claim 29, wherein the quantitative information is selected from the group consisting of bone mass, bone mineral density, and bone structure information.

35. The method according to claim 29, further comprising storing derived data points, calculated from the quantitative information and associated with the subjects' personal and treatment information.

36. The method according to claim 35, wherein the derived data points are selected from the group consisting of subjects' bone mass changes over time, subjects' bone density changes over time, and subjects' bone structures changes over time.

37. The method according to claim 35, wherein the derived data points indicate changes in dermatologic condition of said subjects over time.

38. The method according to claim 35, wherein the derived data points indicate changes in ophthalmic condition of said subjects over time.

39. A system for building a quantitative information database, said system comprising:
a computer program for deriving quantitative information from subjects' medical tests,
a computer receiving database information, said database information comprising said subjects' medical tests, obtained during routine medical or dental care, or said quantitative information derived from said subjects' medical tests, and subjects' personal information, said personal information being selected from the group consisting of demographic information, geographic information, information on risk factors associated with one or more diseases, disease-related factors, and disease-preventive factors, and
a central database collecting data from at least two sources, storing the quantitative information, and associating the quantitative information with the subjects' personal information.

40. The system according to claim 39, wherein said computer further receives subjects' treatment information comprising information regarding treatment that subjects are receiving for said one or more diseases.

41. The system according to claim 39, wherein said central database is installed on said computer.

42. The system according to claim 39, wherein said computer comprises a central system server.

43. The system according to claim 39, wherein said computer comprises a plurality of connected computers.

44. The system according to claim 40, wherein said central database and said treatment information provide data on efficacy of one or more treatments or drugs being administered to said subjects.

45. The system according to claim 40, wherein said central database and said treatment information provide data on market penetration of one or more drugs being administered to said subjects.

46. The system according to claim 39, wherein said computer receives' said database information via a medium selected from the group consisting of a network, e-mail, a data storage medium, a scanner with text recognition software, and manual input.

47. The system according to claim 46, wherein when the medium is a network, the network is selected from the group consisting of the Internet, a local area network, and a network that is accessed via a remote connection.

48. The system according to claim 39, further comprising a plurality of information collection terminals, selected from the group consisting of a personal computer, a notebook computer, an embedded computer, a handheld computer, a personal digital assistant, and a pocket PC, for providing said database information.

49. The system according to claim 39, further comprising user access to said central database via a medium selected from the group consisting of the Internet, a local area network, a network accessed via a remote connection, e-mail, and a data storage medium.

50. The system according to claim 39, wherein said medical tests are selected from the group consisting of liver tests, renal tests, tests for diabetes, EKGs, EEGs, heart disease tests, blood pressure tests, cholesterol tests, and tests for enzyme changes.

51. The system according to claim 39, wherein the central database further stores derived data points, calculated from the quantitative information and associated with the subjects' personal and treatment information.

52. The system according to claim 51, wherein the derived data points are selected from the group consisting of cholesterol changes over time, renal function changes over time, liver function changes over time, heart condition changes over time, blood sugar level changes over time, blood pressure changes over time, and enzyme changes over time.

53. The system according to claim 39, wherein subjects' medical test results, and personal and treatment information are transferred in digital form to said computer.

54. The system according to claim 39, wherein subjects' personal information comprises demographic information.

55. The system according to claim 54, wherein the demographic information comprises information selected from the group consisting of age, gender, race, address, area code, zip or postal code, city, county, state or province, and country.

56. The system according to claim 39, wherein subjects' personal information comprises physical characteristic information.

57. The system according to claim 56, wherein the physical characteristic information comprises information selected from the group consisting of height and weight.

58. The system according to claim 39, wherein subjects' personal information comprises risk factors for a predetermined group of diseases.

59. The system according to claim 58, wherein the predetermined group of diseases are selected from the group consisting of liver related diseases, kidney related diseases, and heart related diseases.

60. The system according to claim 39, wherein subjects' treatment information comprises drug and dosage information.

61. A method of building a quantitative information database, said method comprising:
receiving database information from at least two sources, said database information comprising subjects' medical tests, obtained during routine medical or dental care, or quantitative information derived from said subjects' medical tests, and subjects' personal information, said personal information being selected from the group consisting of demographic information, geographic information, information on risk factors associated with one or more diseases, disease-related factors, and disease-preventive factors,
wherein said receiving comprises either receiving said subjects' medical tests and deriving quantitative information from said subjects' medical tests, or receiving said quantitative information derived from said subjects' medical tests,
storing the quantitative information; and
associating the quantitative information with the subjects' personal information in said database.

62. The method according to claim 61, further comprising receiving subjects' treatment information comprising information regarding treatment that subjects are receiving for said one or more diseases.

63. The method according to claim 62, further comprising providing data on efficacy of one or more treatments or drugs being administered to said subjects.

64. The method according to claim 62, further comprising providing data on market penetration of one or more drugs being administered to said subjects.

65. The method according to claim 61, wherein the medical tests are selected from the group consisting of liver tests, renal tests, tests for diabetes, EKGs, EEGs, heart disease tests, blood pressure tests, cholesterol tests, and tests for enzyme changes.

66. The method according to claim 61, further comprising storing derived data points, calculated from the quantitative information and associated with the subjects' personal and treatment information.

67. The method according to claim 66, wherein the derived data points are selected from the group consisting of cholesterol changes over time, renal function changes over time, liver function changes over time, heart condition changes over time, blood sugar level changes over time, blood pressure changes over time, and enzyme changes over time.

68. A system for building a quantitative information database, said system comprising:
a computer program for deriving quantitative information from subjects' standard x-ray images,
a computer receiving database information, said database information comprising said subjects' standard x-ray images or said quantitative information derived from said subjects' standard x-ray images, and personal information, said personal information being selected from the group consisting of demographic information, geographic information, information on risk factors associated with one or more diseases, disease-related factors, and disease-preventive factors, and
a central database collecting data from at least two sources, storing the quantitative information, and associating the quantitative information with the subjects' personal information.

69. The system according to claim 68, wherein said computer further receives subjects' treatment information comprising information regarding treatment that subjects are receiving for said one or more diseases.

70. The system according to claim 68, wherein said central database is installed on said computer.

71. The system according to claim 68, wherein said computer comprises a central system server.

72. The system according to claim 68, wherein said computer comprises a plurality of connected computers.

73. The system according to claim 69, wherein said central database and said treatment information provide data on efficacy of one or more treatments or drugs being administered to said subjects.

74. The system according to claim 69, wherein said central database and said treatment information provide data on market penetration of one or more drugs being administered to said subjects.

75. The system according to claim 68, wherein said computer receives said database information via a medium selected from the group consisting of a network, e-mail, a data storage medium, a scanner with text recognition software, and manual input.

76. The system according to claim 75, wherein when the medium is a network, the network is selected from the group consisting of the Internet, a local area network, and a network that is accessed via a remote connection.

77. The system according to claim 68, further comprising a plurality of information collection terminals, selected from the group consisting of a personal computer, a notebook computer, an embedded computer, a handheld computer, a personal digital assistant, and a pocket PC, for providing said database information.

78. The system according to claim 68, further comprising user access to said central database via a medium selected from the group consisting of the Internet, a local area network, a network accessed via a remote connection, e-mail, and a data storage medium.

79. The system according to claim 68, wherein the standard x-ray images are selected from the group consisting of dental x-ray images, and medical x-ray images.

80. The system according to claim 68, wherein said standard x-ray images include x-ray images of skeletal areas selected from the group consisting of the hip joint, one or more vertebral bodies, forearm, upper arm, hand, wrist, lower leg, thigh, foot, ankle, knee joint, elbow joint, shoulder joint, ribs, cranium, mandible, or maxilla.

81. The system according to claim 68, wherein the quantitative information is selected from the group consisting of bone mass, bone mineral density, and bone structure information.

82. The system according to claim 69, wherein the central database further stores derived data points, calculated from the quantitative information and associated with the subjects' personal and treatment information.

83. The system according to claim 82, wherein the derived data points are selected from the group consisting of subjects' bone mass changes over time, subjects' bone density changes over time, and subjects' bone structure changes over time.

84. The system according to claim 69, wherein subjects' medical data, and personal and treatment information are transferred in digital form to said separate computer.

85. The system according to claim 68, wherein, when the personal information comprises demographic information, the demographic information comprises information selected from the group consisting of age, gender, race, address, area code, zip or postal code, city, county, state or province, and country.

86. The system according to claim 68, wherein, when the personal information comprises physical characteristic information, the physical characteristic information comprises information selected from the group consisting of height and weight.

87. The system according to claim 68, wherein, when the personal information comprises risk factors for a predetermined group of diseases, the predetermined group of diseases are bone-related diseases.

88. The system according to claim 87, wherein the bone-related diseases are selected from the group consisting of osteoporosis, osteoarthritis, rheumatoid arthritis, and metabolic bone disease.

89. The system according to claim 69, wherein subjects' treatment information comprises drug and dosage information.

90. A method of building a quantitative information database, said method comprising:
receiving database information from at least two sources, said database information comprising subjects' standard x-ray images, or quantitative information derived from said subjects' standard x-ray images, and subjects' personal information, said personal information being selected from the group consisting of demographic information, geographic information, information on risk factors associated with one or more diseases, disease-related factors, and disease-preventive factors,
wherein said receiving comprises receiving said subjects' standard x-ray images and deriving said quantitative information from said subjects' standard x-ray images, or receiving said quantitative information derived from said subjects' standard x-ray images,
storing the quantitative information; and
associating the quantitative information with the subjects' personal information in said database.

91. The method according to claim 90, further comprising receiving subjects' treatment information comprising information regarding treatment that subjects are receiving for said one or more diseases.

92. The method according to claim 91, further comprising providing data on efficacy of one or more treatments or drugs being administered to said subjects.

93. The method according to claim 91, further comprising providing data on market penetration of one or more drugs being administered to said subjects.

94. The method according to claim 90, wherein the standard x-ray images are selected from the group consisting of medical x-rays and dental x-rays.

95. The method according to claim 90, wherein the quantitative information is selected from the group consisting of bone mass, bone mineral density, and bone structure information.

96. The method according to claim 90, further comprising storing derived data points, calculated from the quantitative information and associated with the subjects' personal and treatment information.

97. The method according to claim 96, wherein the derived data points are selected from the group consisting of subjects' bone mass changes over time, subjects' bone density changes over time, and subjects' bone structures changes over time.

98. A method for determining a screening rate for diseases in a system, said system comprising:
a computer receiving database information comprising subjects' medical images or quantitative information derived from said medical images, and personal information; and
a central database storing the quantitative information, associating the quantitative information with geographic regions and with the subjects' personal information, wherein the method comprises:
correlating the geographic regions to census information to produce data in terms of a number of data points per unit of population in one or more of said geographic regions; and
correlating the number of data points to a number of screening tests performed per geographic region per unit of time for a predetermined disease or a group of diseases to produce said screening rate.

99. The method according to claim 98, further comprising receiving subjects' treatment information comprising information regarding treatment that subjects are receiving for said one or more diseases.

100. The method according to claim 99, further comprising providing data on efficacy of one or more treatments or drugs being administered to said subjects.

101. The method according to claim 99, further comprising providing data on market penetration of one or more drugs being administered to said subjects.

102. The method according to claim 98, wherein the medical images are selected from the group consisting of medical x-rays, dental x-rays, computed radiographic images, digital radiographic images, ultrasound images, single x-ray absorptiometry scans, dual x-ray absorptiometry scans, CT scans, MRI scans, PET scans, and SPECT scans.

103. The method according to claim 98, wherein the quantitative information is selected from the group consisting of bone mass, bone mineral density, and bone structure information.

104. The method according to claim 98, further comprising storing derived data points, calculated from the quantitative information and associated with the subjects' personal and treatment information.

105. The method according to claim 104, wherein the derived data points are selected from the group consisting of subjects' bone mass changes over time, subjects' bone density changes over time, and subjects' bone structure changes over time.

106. The method according to claim 104, wherein the derived data points indicate changes in dermatologic condition of said subjects over time.

107. The method according to claim 104, wherein the derived data points indicate changes in ophthalmic condition of said subjects over time.

108. A method for determining a screening rate for diseases in a system, said system comprising:
a computer receiving database information comprising subjects' medical tests, or quantitative data derived from said medical tests, and personal information, and
a central database storing the quantitative information, associating the quantitative information with geographic regions and with the subjects' personal information, wherein the method comprises:
correlating the geographic regions to census information to produce data in terms of a number of data points per unit of population in one or more of said geographic regions; and
correlating the number of data points to a number of screening tests performed per geographic region per unit of time for a predetermined disease or a group of diseases to produce said screening rate.

109. The method according to claim 108, further comprising receiving subjects' treatment information comprising information regarding treatment that subjects are receiving for said one or more diseases.

110. The method according to claim 109, further comprising providing data on efficacy of one or more treatments or drugs being administered to said subjects.

111. The method according to claim 109, further comprising providing data on market penetration of one or more drugs being administered to said subjects.

112. The method according to claim 108, wherein the medical tests are selected from the group consisting of liver tests, renal tests, tests for diabetes, EKGs, EEGs, heart disease tests, blood pressure tests, cholesterol tests, and tests for enzyme changes.

113. The method according to claim 108, further comprising storing derived data points, calculated from the quantitative information and associated with the subjects' personal and treatment information.

114. The method according to claim 113, wherein the derived data points are selected from the group consisting of cholesterol changes over time, renal function changes over time, liver function changes over time, heart condition changes over time, blood sugar level changes over time, blood pressure changes over time, and enzyme changes over time.

115. A method for producing market penetration data of different drugs in geographical regions, said system comprising:
a computer receiving database information comprising subjects' medical images or quantitative data derived from medical images, personal information, and treatment information, said treatment information comprising identifying information for one or more drugs taken by the subjects for one or more disorders; and
a central database storing the medical images or the quantitative data derived from medical images, associated with the subjects' personal and treatment information,
wherein said method comprises:
correlating respective drugs to geographic information;
obtaining numbers of subjects on each of the respective drugs in each geographic region identified by the geographic information; and
correlating the numbers of subjects to a reference, wherein the reference is selected from the group consisting of census information, and a total number of subjects on each of the respective drugs.

116. The method according to claim 115, wherein the stored database information is time-stamped.

117. The method according to claim 116, wherein the geographic information comprises information selected from the group consisting of address, area code, zip or postal code, city, county, state or province, and country of the subjects.

118. The method according to claim 117, wherein the method further comprises normalizing the market penetration data according to the subjects' personal information.

119. The method according to claim 118, wherein the personal information is selected from the group consisting of demographic information, physical characteristic information of said subjects, and risk factors for a predetermined group of diseases.

120. The system according to claim 115, wherein the medical images are selected from the group consisting of medical x-rays, dental x-rays, computed radiographic images, digital radiographic images, ultrasound images, single x-ray absorptiometry scans, dual x-ray absotptiometry scans, CT scans, MRI scans, PET scans, and SPECT scans.

121. A method for producing market penetration data of different drugs in geographical regions, said system comprising:
a computer receiving database information comprising subjects' medical tests or quantitative data derived from medical tests, personal information, and treatment information, said treatment information comprising identifying information for one or more drugs taken by the subjects for one or more disorders; and
a central database storing the medical tests or the quantitative data derived from the medical tests, associated with the subjects' personal and treatment information,
wherein said method comprises:
correlating respective drugs to geographic information;
obtaining numbers of subjects on each of the respective drugs in each geographic region identified by the geographic information; and
correlating the numbers of subjects to a reference, wherein the reference is selected from the group consisting of census information, and a total number of subjects on each of the respective drugs.

122. The method according to claim 121, wherein the stored database information is time-stamped.

123. The method according to claim 122, wherein the geographic information comprises information selected from the group consisting of address, area code, zip or postal code, city, county, state or province, and country of the subjects.

124. The method according to claim 123, wherein the method further comprises normalizing the market penetration data according to the subjects' personal information.

125. The method according to claim 124, wherein the personal information is selected from the group consisting of demographic information, physical characteristic information of said subjects, and risk factors for a predetermined group of diseases.

126. The method according to claim 121, wherein the medical tests are selected from the group consisting of liver tests, renal tests, tests for diabetes, EKGs, EEGs, heart disease tests, blood pressure tests, cholesterol tests, and tests for enzyme changes.

127. A method for producing market penetration data of different drugs in certain regions by a system, said system comprising:
a computer receiving database information comprising subjects' medical images or quantitative data derived from medical images, personal information, and treatment information, said treatment information comprising identifying information for one or more drugs taken by the subjects for one or more disorders; and
a central database storing the quantitative data derived from medical images or the quantitative data derived from medical images, associated with the subjects' personal and treatment information,
wherein said method comprises, for the one or more disorders:
correlating respective drugs, administered for the one or more disorders, to geographic information;
obtaining the consumption amount of each of the respective drugs in each region identified by the geographic information; and
correlating that consumption amount of each of the respective drugs to the sum of the consumption amount of all of the respective drugs.

128. The method according to claim 127, wherein the stored database information is time-stamped.

129. The method according to claim 128, wherein the geographic information comprises information selected from the group consisting of address, area code, zip or postal code, city, county, state or province, and country of the subjects.

130. The method according to claim 129, wherein the method further comprises normalizing the market penetration data according to the subjects' personal information.

131. The method according to claim 130, wherein the personal information is selected from the group consisting of demographic information, physical characteristic information of said subjects, and risk factors for a predetermined group of diseases.

132. The system according to claim 127, wherein the medical images are selected from the group consisting of medical x-rays, dental x-rays, computed radiographic images, digital radiographic images, ultrasound images, single x-ray absorptiometry scans, dual x-ray absorptiometry scans, CT scans, MRI scans, PET scans, and SPECT scans.

133. A method for producing market penetration data of different drugs in certain regions by a system, said system comprising:
a computer receiving database information comprising subjects' medical tests or quantitative data derived from medical tests, personal information, and treatment information, said treatment information comprising identifying information for one or more drugs taken by the subjects for one or more disorders; and
a central database storing the quantitative data derived from medical tests or the quantitative data derived from medical tests, associated with the subjects' personal and treatment information,
wherein said method comprises, for the one or more disorders:
correlating respective drugs, administered for the one or more disorders, to geographic information;
obtaining the consumption amount of each of the respective drugs in each region identified by the geographic information; and
correlating that consumption amount of each of the respective drugs to the sum of the consumption amount of all of the respective drugs.

134. The method according to claim 133, wherein the stored database information is time-stamped.

135. The method according to claim 134, wherein the geographic information comprises information selected from the group consisting of address, area code, zip or postal code, city, county, state or province, and country of the subjects.

136. The method according to claim 135, wherein the method further comprises normalizing the market penetration data according to the subjects' personal information.

137. The method according to claim 136, wherein the personal information is selected from the group consisting of demographic information, physical characteristic information of said subjects, and risk factors for a predetermined group of diseases.

138. The method according to claim 133, wherein the medical tests are selected from the group consisting of liver tests, renal tests, tests for diabetes, EKGs, EEGs, heart disease tests, blood pressure tests, cholesterol tests, and tests for enzyme changes.

139. A method for comparing efficacy of different drugs by a system, said system comprising:
a computer receiving database information comprising subjects' medical images or quantitative data derived from medical images, personal information, and treatment information, said treatment information comprising identifying information for one or more drugs taken by the subjects for one or more disorders; and
a central database storing the quantitative data derived from medical images or the quantitative data derived from medical images, associated with the subjects' personal and treatment information,
wherein the method comprises:
grouping subjects into groups by the drugs taken; and
obtaining derived data points by comparing quantitative information from subsequent medical images with respect to that of a baseline medical image taken of each subject in each of said groups.

140. The method according to claim 139, wherein the method further comprises normalizing the derived data points by subjects' personal information.

141. The method according to claim 140, wherein the personal information is selected from the group consisting of demographic information, physical characteristic information, and risk factors for a predetermined group of diseases.

142. The system according to claim 139, wherein the medical images are selected from the group consisting of medical x-rays, dental x-rays, computed radiographic images, digital radiographic images, ultrasound images, single x-ray absorptiometry scans, dual x-ray absorptiometry scans, CT scans, MRI scans, PET scans, and SPECT scans.

143. The method according to claim 139, wherein the derived data points are selected from the group consisting of bone mass changes over time, bone mineral density changes over time, and bone structure change over time.

144. A method for comparing efficacy of different drugs by a system, said system comprising:
a computer receiving database information comprising subjects' medical tests or quantitative data derived from medical tests, personal information, and treatment information, said treatment information comprising identifying information for one or more drugs taken by the subjects for one or more disorders; and
a central database storing the quantitative data derived from medical tests or the quantitative data derived from medical tests, associated with the subjects' personal and treatment information,
wherein the method comprises:
grouping subjects into groups by the drugs taken; and
obtaining derived data points by comparing quantitative information from subsequent medical tests with respect to that of a baseline medical test performed on each subject in each of said groups.

145. The method according to claim 144, wherein the method further comprises normalizing the derived data points by subjects' personal information.

146. The method according to claim 145, wherein the personal information is selected from the group consisting of demographic information, physical characteristic information, and risk factors for a predetermined group of diseases.

147. The method according to claim 144, wherein the medical tests are selected from the group consisting of liver tests, renal tests, tests for diabetes, EKGs, EEGs, heart disease tests, blood pressure tests, cholesterol tests, and tests for enzyme changes.

148. The method according to claim 144, wherein the derived data points are selected from the group consisting of bone mass changes over time, bone mineral density changes over time, and bone structure change over time.

149. A system for providing quantitative information to a central database for tracking treatment efficacy, said system comprising a plurality of information collection terminals receiving data selected from the group consisting of medical images, dental images, dermatological tests, ophthalmological tests, and laboratory tests, said plurality of information collection terminals also receiving subjects' treatment information, wherein said treatment information provides data regarding said treatment efficacy.

150. A system for providing quantitative information to a central database for tracking market penetration of drugs, said system comprising a plurality of information collection terminals receiving data selected from the group consisting of medical images, dental images, dermatological tests, ophthalmological tests, and laboratory tests, said plurality of information collection terminals also receiving subjects' personal information, said subjects' personal information including geographic information, said information collection terminals also receiving subjects' drug administration information, wherein said drug administration information, together with said geographic information, in said central database, provides data regarding said market penetration.

151. A system as claimed in claim 1, wherein the at least two sources are selected from the group consisting of healthcare provider offices and dental provider offices.

152. A method as claimed in claim 29, wherein the at least two sources are selected from the group consisting of healthcare provider offices and dental provider offices.

153. A system as claimed in claim 39, wherein the at least two sources are selected from the group consisting of healthcare provider offices and dental provider offices.

154. A method as claimed in claim 61, wherein the at least two sources are selected from the group consisting of healthcare provider offices and dental provider offices.

155. A system as claimed in claim 68, wherein the at least two sources are selected from the group consisting of healthcare provider offices and dental provider offices.

156. A method as claimed in claim 90, wherein the at least two sources are selected from the group consisting of healthcare provider offices and dental provider offices.

157. A system for providing assurance of quality of subjects' medical images, said system comprising:
a computer receiving either said subjects' medical images or said quantitative information derived from said subjects' medical images from a remotely located site; and
a computer program for performing quality checks on the subjects' medical images, wherein the medical images are selected from the group consisting of x-ray, ultrasound, single x-ray absorptiometry, dual x-ray absorptiometry, CT, MRI, radionuclide, SPECT scan, PET scan or data derived from analysis of medical photographic techniques, laser enhanced imaging, and various biomicroscopy techniques, and
wherein the quality checks are selected from the group consisting of assessments of image quality, assessments of image resolution, and assessments of image contrast.

158. A system as claimed in claim 157, wherein said quality checks are fully automated.

159. A system as claimed in claim 157, wherein said quality checks are carried out with human interaction.

160. A system as claimed in claim 157, wherein said quality checks are carried out on a sample of the subjects' medical images.

161. A system as claimed in claim 157, wherein said quality checks are carried out on a portion of selected ones of the subjects' medical images.

162. A system as claimed in claim 157, wherein said quality checks are fully automated.
